(19) United States
(12) Patent Application Publication
(10) Pub. No.: US 2026/0149790 A1
(43) Pub. Date: May 28, 2026

(54) Video Conference Systems that Facilitate Fluent Communications

(71) Applicant: fluency AI, LLC, Arlington, MA (US)

(72) Inventors: Steven Douglas Scott, Arlington, MA (US); Jason T. Stillerman, Arlington, MA (US)

(21) Appl. No.: 19/395,936

(22) Filed: Nov. 20, 2025

Related U.S. Application Data
(60) Provisional application No. 63/723,643, filed on Nov. 22, 2024.
(60) Provisional application No. 63/882,791, filed on Sep. 16, 2025.

(51) Int. Cl. H04N 7/15; G06T 11/60; G06T 13/20; G06T 13/40; G10L 13/08; G10L 15/26; G10L 21/10

(52) U.S. Cl. CPC H04N 7/157; G06T 11/60; G06T 13/205; G06T 13/40; G10L 13/08; G10L 15/26; G10L 21/10; G10L 2021/105

(57) ABSTRACT

A video conference system and method that provides fluent representations of speech of disfluent participants, such as stutterers, to other participants in a video conference session. In embodiments of the system, a fluent digital twin video conference server application (FDT video conference server) on a server computer system establishes the sessions, receives original audio from a disfluent participant via an FDT-compatible video conference client on a client computer system, converts the original audio into one or more fluent representations of speech, and transmits the fluent representations of speech to other session participants. In other embodiments, a fluent digital twin video conference client application (FDT video conference client) receives and converts original audio of a disfluent participant into one or more fluent representations of speech and transmits the fluent speech to a standard video conference server, which then forwards the fluent speech to other session participants.

### RELATED APPLICATIONS

This application claims the benefit under 35 USC 119 (e) of the following previously filed applications: U.S. Provisional Application No. 63/723,643 filed on Nov. 22, 2024, and U.S. Provisional Application No. 63/882,791 filed on Sep. 16, 2025, all of which are incorporated herein by reference in their entireties.

This application is also related to U.S. application Ser. No. 19/269,204 filed on Jul. 15, 2025, entitled “Speech Therapy System and Method Therefor”.

### FIELD OF THE INVENTION

The invention relates generally to video conference systems that allow speech disfluent individuals such as people who stutter to communicate fluently over communications networks.

### BACKGROUND OF THE INVENTION

Stuttering is a serious speech fluency disorder that affects people of all ages and disrupts their normal flow of speech. Stuttering affects approximately 3.0 to 5.0 percent of preschool-aged children and 0.7 to 1.0 percent of the general population worldwide. Stuttering is characterized by speech disruptions including frequent repetitions or prolongations of speech sounds, syllables or words, and interruptions during speech including the inability to begin speaking a word or hesitation when speaking. These speech disruptions may be accompanied by muscle movements including rapid eye blinks, tremors of the lips or jaw or other “struggle behaviors” of the face or upper body that an individual who stutters may exhibit when speaking. A person who stutters (PWS) is also known as a stutterer.

Stutterers often experience a fear or anticipation of disfluencies on particular sounds, words, or word combinations, generally on those for which they have stuttered previously. Consequently, stutterers sometimes ‘scan ahead’ their upcoming conversational speech for problematic words to identify acceptable synonyms that they can pronounce fluently. Some stutterers are sufficiently practiced at word-avoidance so that their stuttering is not noticeable to casual listeners. At the same time, there remains a strong psychological strain on the stutterer, including the fear of not finding an acceptable substitute word in time. As a result, stutterers often limit or avoid problematic conversational situations such as talking on the telephone. In severe cases, stutterers may avoid conversation generally, leading to acute social isolation.

Even in mild and moderate cases, stutterers experience considerable embarrassment, and stuttering often interferes with academic and professional achievement. Studies have shown that stutterers earn on average $7000 annually less than non-stutterers with matched credentials and education. See Hope Gerlach, Evan Totty, Anu Subramanian, and Patricia Zebrowski, “Stuttering and Labor Market Outcomes in the United States”, Journal of Speech, Language, and Hearing Research 61 (July 2018), pages 1649-1663. Additionally, in surveys of people who stutter, 70% agreed that stuttering decreases the likelihood of being hired or promoted. See Joseph Klein and Stephen B. Hood, “The impact of stuttering on employment opportunities and Job Performance”, Journal of Fluency Disorders 29 (4) 2004, pages 255-273. Summed over the United States' working adult population, in one example, this amounts to an economic income loss income of roughly $10 billion annually. Since the prevalence of stuttering is reasonably constant across nations, the worldwide loss of income is considerably greater.

Video conference systems allow participants at client computer systems to communicate with one another over communications networks, such as the Internet. For this purpose, the video conference systems include video conference programs that include client and server software components. These components include a video conference server application installed on/hosted by a server computer system, and video conference client applications installed on/hosted by the client computer systems. Example client computer systems include workstations, laptops, computer tablets and mobile phones/smartphones with mobile operating systems such as Google Android, Apple IOS, and Linux, in examples. The video conference server applications are also known as video conference servers, and the video conference client applications are also known as video conference clients. Example video conference programs include Zoom, Google Meet, Webex and Microsoft Teams, in examples.

More detail for the video conference programs is as follows. The video conference server establishes a video conference session between two or more participants, where each participant joins the session via the video client application executing upon the participant's client computer system. The video conference server authorizes each participant, controls join and exit requests, receives the audio and video sent from each participant, and communicates the audio and video sent by each participant to the other participants over the network. The video conference sessions are also known as video conference calls.

Each video conference session typically includes audio and video of the participants. For this purpose, each participant typically uses existing hardware components of the client computer systems to create the audio and video. These existing components include microphones and video cameras, respectively. Each participant uses the video conference client at their client computer system to control the hardware components and create the audio and video (also known as audio streams and video streams), and to selectively enable and disable the audio and video. When a participant enables their audio or video, the participant's video conference client sends the enabled audio and/or video to the video conference server. In a similar vein, when a participant disables their audio or video, the participant's video conference client does not send the enabled audio and/or video to the video conference server. In some implementations, the server can receive audio and/or video signals sent from selected users, and suppress these signals from being communicated to other session participants, for example when there are many session participants. In another implementation, the audio sent from most users may be suppressed by the server to avoid polluting the downloaded audio with spurious audio from one or two users who forget to mute their microphones.

Developing a therapy which restores fluent speech to disfluent individuals such as people who stutter has been a goal of speech-language pathologists and stuttering researchers since the 1930's, but a therapy that provides long-term relief for most people who stutter has proven elusive. Until an effective therapy is developed, there is a need to enable stutterers to communicate fluently at least temporarily during video conference calls.

With the arrival of Covid-19 to the United States in 2020, many corporations, institutions, and schools adopted remote-work policies that allowed workers and students to work from home. To maintain strong interpersonal communications in the absence of in-person conversations, these organizations relied heavily on video conference technology to allow their workers to communicate with one another both audibly and visually. The video conference programs have been adopted widely throughout the United States and worldwide. ‘Hybrid’ meetings that include a mixture of in-person and remote participants continue to be popular even as Covid-19 restrictions have been loosened.

The fact that tens of millions of people already have the same existing video conference clients installed on their client computer systems, and the fact that these people know how to use the video conference programs, present a unique opportunity to add new capabilities including the ability to allow stuttering users to communicate fluently with their colleagues. Enabling stutterers to communicate fluently during video conference sessions would significantly reduce their stress associated with the anticipation of disfluent speech and would markedly improve the effectiveness of their communication.

There are also United States laws and agencies that require accommodations for stutterers. Under the Americans with Disabilities Act, for example, stuttering can be considered a disability if it substantially limits one or more major life activities, such as speaking or communicating. The United States Federal Communications Commission (FCC) also requires equipment manufacturers and service providers to make their products and services accessible to people with disabilities, such as stutterers, if doing so is “readily achievable.” See Section 255 of the Telecommunications Act of 1966.

### SUMMARY OF THE INVENTION

Systems and methods are proposed to enable disfluent individuals including people who stutter to engage in fluent conversation over communication networks. During this process, the system ensures that the disfluent users' original audible speech is not heard by people other than themselves. A recent 2021 study found that a set of 24 stutterers experienced near-perfect fluency when they were convinced that they were truly alone and that their speech was not being recorded. See. E. S. Jackson, L. R. Miller, H. J. Warner, and J. S. Yaruss, “Adults who stutter do not stutter during private speech”, J. Fluency Disorders 70 (2021) 105878, (hereinafter “Jackson 2021”). By contrast, stutterers' fluency often decreases in situations where the social consequences of stuttering are greater, such as when speaking before a group. To wit, according to Jackson 2021, “ . . . speakers' perceptions of listeners, whether real or imagined, play a critical and likely necessary role in the manifestation of stuttering events.” Id.

Software modules that transcribe speech into text (STT) have been available for several decades, and their transcription accuracy and speed have been improving over time. These software modules are also known as STT apps or modules. Recent advances in STT performance based on artificial-intelligence (AI) modules that employ Large Language Models (LLMs) provide very accurate transcription in near-real time at very low cost. For example, the Whisper STT module introduced in September 2022 advertised: “Introducing Whisper. We've trained and are open-sourcing a neural net called Whisper that approaches human level robustness and accuracy on English speech recognition.”

For clarity of discussion, a system and method are proposed that represent a stuttering user as a fluent conversation partner, otherwise known as a ‘fluent digital twin (FDT)’ of the user. The proposed system typically includes an STT app and may include a text-to-speech (TTS) app that generates synthetized audible speech from the transcribed text. Very recently, speech-to-speech apps have been developed that accept user speech as input and provide modified user speech as output. These apps transition directly from speech-in to speech-out, i.e., without invoking the more customary approach of STT followed by TTS (text to speech) processing. See, for example, the Hibiki app being developed by Kyuati, T. Labiausse et al., “High-Fidelity Simultaneous Speech-to-Speech Translation,” submitted to Computation and Language on 5 Feb. 2025, arXiv: 2502.03382v2).

If the user is not in the physical presence of other people during the video conference session, then by the findings of Jackson (Jackson 2021), it is expected that the audio speech signal of a stuttering user that is transmitted to the STT app would be fluent. As a result, the text output would be free of disfluent syllables or repeated words. But in addition, there is a peculiar and very helpful feature of some STT software modules that are based on Large Language Models: they effectively ‘erase’ stuttered utterances, i.e., the text transcription contains only fluent-looking text that is free of disfluent syllables. For example, the spoken utterance ‘con-con-constitution’ might appear only as ‘constitution’ in the transcription. It is believed that this behavior derives from the ‘training set’ used in preparation of the Large Language Model, which is presumably based mostly or entirely on the speech of fluent speakers.

Transcription of stutterers' speech by automatic speech recognition software programs (ASRs) is an active field of research, and improving the accuracy of such transcriptions is an objective of research programs. See Dena Mujtaba, Nihar Mahapatra, Megan Arney, J. Scott Yaruss, Hope Gerlach-Houck, Caryn Herring, and Jia Bin, “Lost in Transcription: Identifying and Quantifying the Accuracy Biases of Automatic Speech Recognition Systems against Disfluent Speech”, Proceedings of the 2024 Conference of North American Chapter of the Association for Computational Linguistics: Human Language Technologies (Volume I: Long Papers), pages 4795-4809 Jun. 16-21, 2024. But although it has been reported that some ASR programs achieve impressive transcription accuracy of stutterers' speech (op. cit, p. 4797), the fact that some disfluencies in the original speech do not appear in the transcription—and in particular the fact that such behavior might be used to create a fluent transcription of the original speech that could be used for fluent communication by stutterers in video conference sessions-seems to have been underappreciated or overlooked.

The underlying cause of the disfluency-erasing nature of LLM-based STT apps is unimportant for purposes of this disclosure. Rather, the relevant point is the benefit that some LLM-based STT apps provide, namely, that a stuttering user's transcribed speech (in text format) will appear more fluent than the user's original speech. Current LLM-based STT apps do not typically remove repeated “filler words” or interjections such as “um”, “uh”, and “like”. But once an STT app has generated a partially fluency “sanitized” transcription, that transcription can be quickly and inexpensively postprocessed by an artificial intelligence (AI) software component that is instructed to remove unnecessary duplicated words and interjections. The combination of LLM/STT speech processing and postprocessing of the transcription by an AI engine yields a transcription that is remarkably free from disfluencies, even if the original speech is highly disfluent.

The combination of a stuttering user's improved fluency by virtue of speaking while alone, and the erasure of some or most of any residual disfluent utterances of a user's speech by an LLM-based STT app, allows the user to create a fluent representation of his or her speech that can be transmitted to video conference session participants over a communications network during a video conference session.

Embodiments of the proposed system integrate FDT capability into either the server components or the client components of the existing video conference programs. Alternatively, in another embodiment, the FDT capabilities of the proposed system can be implemented in a custom web browser, without the need to make any modifications to the existing video conference programs. If the system disclosed herein were to be implemented by the existing video conference programs, or in new video conference programs, the ubiquity of video conference usage would then enable disfluent users to communicate fluently with other participants in video conference sessions.

In the absence of FDT capability, the conversational environment of existing video conference sessions approximates that of in-person conversations, during which stutterers generally both anticipate and experience disfluent speech. Adding FDT capability to video conference services/video conference programs improves the experience of stuttering users during video conference sessions; it is believed that this capability will transform the stuttering user's audiovisual experience from one of dreaded anticipation of disfluent speech, to an anticipation (or possibly even expectation) of fluent speech.

This disclosure describes a variety of embodiments of video conference systems that can incorporate FDT capability into either a server component or a client component of a video conference program. These embodiments differ in the composition of the audio, video, and/or text signals that are transmitted from a stuttering user to other participants in a video conference session. Henceforth, other participants in a video conference session are also known as Remote Conversation Partners (RCPs) of the stuttering user. When the proposed video conference systems described hereinbelow incorporate FDT capability into their video conference servers, where the video conference servers execute on server computer systems, the video conference servers are referred to as FDT video conference servers. In a similar vein, when the proposed video conference systems incorporate FDT capability into video conference clients executing on client computer systems, the video conference clients are referred to as FDT video conference clients.

The proposed video conference systems, and their FDT video conference servers and FDT video conference clients, include or otherwise access various software components. Software modules are software components which typically do not have a “main” function; rather, their code statements are packaged as libraries in subroutine or function format, and are linked either statically or dynamically with other software components, such as with the FDT video conference clients and FDT video conference servers. The FDT video conference clients and FDT video conference servers, in turn, then call or reference the subroutines or functions in the software modules. The software modules may be locally hosted on the FDT video conference clients/client computer systems and FDT video conference servers/server computer systems, hosted on other components of the video conference systems, or on one or more remote servers, in examples.

When one or more of the software modules (e.g., speech-to-text, text-to-speech, speech-to-speech, and the like) are hosted on one or more remote servers, they are typically included as part of one or more software services. The video conference systems and their FDT video conference servers and FDT video conference clients can then subscribe to these software services to access the software modules therein. It can also be appreciated that a combination of locally and remotely hosted software modules may be utilized by the video conference systems and their FDT video conference servers and FDT video conference clients.

In embodiments of the proposed FDT-enabled video conference system disclosed herein, audio signals that are transmitted from a stuttering user to RCPs can either include (a) no audio at all; or (b) synthetic audible speech that is an audible representation of a text stream. This text stream is preferably transcribed from the original spoken words of the user via an STT module. Option (b) is sometimes referred to as being an audio voice ‘clone’ of a speaking user for the following reasons: the user's speech is transcribed into text by the STT module, and then the resultant transcribed text is reconverted back into an audio signal by a text-to-speech (TTS) module, in which the outgoing audio signal can be synthesized to resemble the ‘voice’ of the user or it can be synthesized to resemble a different ‘voice’ from that of the user.

In the proposed system, the original audible speech of a stuttering user is never transmitted to any RCP. In contrast, in all embodiments of the proposed system, the stuttering user's original speech is transformed into one or more fluent representations of user speech, whether transcribed into a fluent text-based representation by an STT module, or converted directly into fluent synthetic speech, without first being transcribed into text, in examples. The embodiments of the system then send one or more of the fluent representations of the user speech to the RCPs.

In the various embodiments of the system described herein, the video signals that are transmitted from a stuttering user to one or more RCPs can be either a) original video images of the user, as captured by a standard computer video camera; b) original video images of the user, as captured by a standard computer video camera, along with the user's transcribed speech superimposed on the video images as text; c) a static image of the user; d) an avatar; e) a static image along with the user's transcribed speech superimposed on the static image as text; or f) an avatar, along with the user's transcribed speech superimposed on the avatar. In one example, the static image might be extracted from the original video. Alternately, the system provides a separate capability for the user to upload a static image.

In general, according to one aspect, the invention features a video conference system including a server computer system and a first client computer system. The server computer system includes a processor, a memory, and a fluent digital twin video conference server application, also known as an FDT video conference server. The FDT video conference server is loaded into the memory and executed by the processor. The first client computer system includes an FDT-compatible video conference client that is loaded into a memory of and is executed by a processor of the first client computer system. The FDT-compatible video conference client includes a client graphical user interface (client GUI) and user configuration data. The stuttering participant accesses the client GUI to modify the user configuration data, and the FDT-compatible video conference client is configured to receive original audio and original video of the stuttering participant.

The FDT video conference server is further configured to: establish a video conference session that includes the stuttering participant and one or more other participants; receive the user configuration data, the original audio and the original video of the stuttering participant over the video conference session, sent from the FDT-compatible video conference client; create one or more fluent representations of speech of the stuttering participant based upon the user configuration data and from at least the original audio; and transmit the one or more fluent representations of speech of the stuttering participant over the video conference session to the one or more other participants.

In one embodiment, the FDT video conference server includes a speech-to-text module and a video combiner module. The speech-to-text module is configured to transcribe the original audio of the stuttering participant into fluent transcribed text, and the video combiner module is configured to superimpose the fluent transcribed text upon the original video of the stuttering participant to create a composite video signal. Here, the one or more fluent representations of speech of the stuttering participant include the fluent transcribed text of the composite video signal.

In another embodiment, the video conference system includes a speech-to-text module included in the FDT video conference server and includes a voice clone module. The speech-to-text module transcribes the original audio of the stuttering participant into fluent transcribed text, and the voice clone module is configured to: receive the fluent transcribed text and a voice clone request message as inputs, the voice clone request message including a voice clone descriptor of a selected individual, and where the voice clone descriptor is obtained from and also included within the user configuration data; obtain voice clone data for the voice clone descriptor in the voice clone request message; and generate an audio representation of the fluent transcribed text, in a voice of the selected individual associated with the voice clone data in response. The audio representation of the fluent transcribed text in the voice of the selected individual is also known as fluent synthetic speech. Here, the one or more fluent representations of speech of the stuttering participant include the fluent synthetic speech.

In one implementation, the voice clone module is included within another computer system that is different from and in communication with the server computer system. In another implementation, the voice clone module is included within the FDT video conference server.

In another embodiment, the user configuration data includes a descriptor associated with a static image of the user, and the FDT video conference server is configured to obtain the static image from the memory using the descriptor, and to transmit the static image along with the fluent synthetic speech to the one or more other participants.

In yet another embodiment, the FDT video conference server is configured to receive the original video of the stuttering participant from the FDT-compatible video conference client, and to transmit the original video along with the fluent synthetic speech to the one or more other participants.

In yet another embodiment, the video conference system further includes an avatar generator module. The avatar generator module is configured to: receive an avatar name request message that includes an avatar descriptor of a selected avatar, where the avatar descriptor is obtained from and also included in the user configuration data; obtain avatar data for the avatar descriptor in the avatar name request message; and replace the original video of the stuttering participant with an avatar video signal that includes the avatar data. In one example, the avatar data includes at least lip movements that are consistent with the fluent synthetic speech. Then, the FDT video conference server is configured to transmit the avatar video signal along with the fluent synthetic speech to the one or more other participants.

In yet another embodiment, the video conference system further includes a speech-to-speech module that is included in the FDT video conference server. The speech-to-speech module is configured to: receive the original audio of the stuttering participant, and a voice clone name request message that includes a voice clone descriptor of a selected voice clone, where the voice clone descriptor is obtained from and also included within the user configuration data; perform a lookup of the voice clone descriptor at a voice clone library, to obtain voice clone data of the selected individual associated with the voice clone descriptor; and create a fluent audio signal from the original audio, presented in a cloned voice, where the cloned voice is based upon the voice clone data of the selected individual. Here, the one or more fluent representations of speech of the stuttering participant include the fluent audio signal presented in the cloned voice.

Moreover, in the video conference system, the FDT video conference server is configured such that the FDT video conference server does not transmit the original audio of the stuttering participant to the one or more other participants.

In general, according to another aspect, the invention features another video conference system. The video conference system includes a server computer system and a first client computer system. The server computer system includes a video conference server application, also known as a video conference server, that is configured to establish video conference sessions that include audio and video of participants. The first client computer system includes a processor, a memory and a fluent digital twin video conference client application, also known as an FDT video conference client, that is loaded into the memory and executed by the processor. The FDT video conference client includes a client GUI and user configuration data.

In more detail, a stuttering individual participant configures the FDT video conference client to receive original audio and original video of the stuttering participant, and the stuttering participant accesses the client GUI to modify the user configuration data. The FDT video conference client is configured to create one or more fluent representations of speech of the stuttering participant based upon the user configuration data and from at least the original audio. Additionally, upon the video conference server establishing a video conference session that includes the stuttering participant and one or more other participants, the FDT video conference client is configured to transmit the one or more fluent representations of speech of the stuttering participant over the video conference session to the video conference server, and the video conference server transmits the one or more fluent representations of speech of the stuttering participant over the video conference session to the one or more other participants.

In an embodiment, the FDT video conference client includes a speech-to-text module and a video combiner module. The speech-to-text module is configured to transcribe the original audio of the stuttering participant into fluent transcribed text, and the video combiner module is configured to superimpose the fluent transcribed text upon the original video of the stuttering participant to create a composite video signal. Here, the one or more fluent representations of speech of the stuttering participant include the fluent transcribed text of the composite video signal.

In another embodiment, the video conference system includes a speech-to-text module included in the FDT video conference client, and a voice clone module. The speech-to-text module is configured to transcribe the original audio of the stuttering participant into fluent transcribed text, and the voice clone module is configured to: receive the fluent transcribed text and a voice clone request message as inputs, the voice clone request message including a voice clone descriptor of a selected individual, where the voice clone descriptor is obtained from and also included within the user configuration data; obtain voice clone data for the voice clone descriptor in the voice clone request message; and generate an audio representation of the fluent transcribed text that is presented in a voice of the selected individual associated with the voice clone data in response. For this purpose, the audio representation of the fluent transcribed text presented in the voice of the selected individual is also known as fluent synthetic speech. Here, the one or more fluent representations of speech of the stuttering participant include the fluent synthetic speech.

In one implementation, the voice clone module is included within another computer system that is different from and in communication with the client computer system. In another implementation, the voice clone module is included within the FDT video conference client.

In another embodiment, the user configuration data includes a descriptor associated with a static image of the user, and the FDT video conference client is configured to: obtain the static image from the memory using the descriptor; access a static image selected by the stuttering participant from the memory; and send the static image as the video of the stuttering participant to the video conference server. The video conference server then transmits the static image along with the fluent synthetic speech to the one or more other participants.

In yet another embodiment, the FDT video conference client is configured to receive the original video of the stuttering participant from a video camera connected to the first client computer system, and to send the original video of the stuttering participant along with the fluent synthetic speech to the video conference server. The video conference server then transmits the original video of the stuttering participant along with the fluent synthetic speech to the one or more other participants.

In yet another embodiment, the FDT video conference client includes an avatar generator module that is configured to replace the original video of the stuttering participant with avatar video of an avatar selected by the stuttering participant. The selected avatar is indicated by an avatar descriptor included in the user configuration data. The FDT video conference client is further configured to send the avatar video along with the fluent synthetic speech to the video conference server, and the video conference server transmits the avatar video along with the fluent synthetic speech to the one or more other participants. In one example, the avatar video includes lip movements that are informed by the fluent synthetic speech.

Moreover, the FDT video conference client is configured such that the FDT video conference client does not transmit the original audio of the stuttering participant to the video conference server.

In general, according to yet another aspect, the invention features a method of an FDT video conference server. The method comprises the FDT video conference server performing the following steps: 1) receiving original user speech of a stuttering user, in the form of original audio signals, sent from a FDT-compatible video conference client of the user, where the user is a participant in a video conference session established by the FDT video conference server; 2) receiving original video of the stuttering user, in the form of original video signals, sent from the FDT-compatible video conference client; 3) receiving user configuration data sent from the FDT-compatible video conference client; 4) creating one or more fluent representations of speech of the user, based upon the user configuration data and from at least the original audio signals; 5) creating replacement video signals that are either based on the original video signals, or that are not based upon the original video signals; and 6) transmitting the one or more fluent representations of speech, along with the original video signals or the replacement video signals, to other participants of the video conference session.

In general, according to yet another aspect, the invention features a method of an FDT video conference client. The FDT video conference client is in communication with a video conference server. The method comprises the FDT video conference client performing the following steps: 1) receiving original user speech of a stuttering user, in the form of original audio signals obtained by and sent from a microphone at the FDT video conference client, where the user is a participant in a video conference session established by the video conference server; 2) receiving original video of the stuttering user, in the form of original video signals, obtained by and sent from a video camera at the FDT video conference client; 3) accessing user configuration data created in response to user configuration of a client GUI, where the client GUI is included in the FDT video conference client; 4) creating one or more fluent representations of speech of the user, based upon the user configuration data and from at least the original audio signals; 5) creating replacement video signals that are either based on the original video signals, or that are not based upon the original video signals; and 6) transmitting the one or more fluent representations of speech, along with the original video signals or the replacement video signals, to the video conference server, the video conference server then forwarding the one or more fluent representations of speech, along with the original video signals or the replacement video signals, to other participants of the video conference session.

In general, according to still another aspect, the invention features a video conference system, the system comprising a client computer system including a processor and a memory, and an FDT-enabled web browser loaded into the memory and executed by the processor. The FDT-enabled web browser includes a video conference client.

The FDT-enabled web browser is configured to: 1) receive original user speech of a stuttering user, in the form of original audio signals obtained by and sent from a microphone at the video conference client, where the user is a participant in a video conference session established by a video conference server in communication with the video conference client; 2) receive original video of the stuttering user, in the form of original video signals, obtained by and sent from a video camera at the video conference client; 3) convert the original audio signals into one or more fluent representations of speech of the user; 4) create replacement video signals that are either based on the original video signals, or that are not based upon the original video signals; and transmit the one or more fluent representations of speech, along with the original video signals or the replacement video signals, to the video conference client. The video conference client then forwards the one or more fluent representations of speech, along with the original video signals or the replacement video signals, over a network to the video conference server. The video conference server, in turn, forwards the one or more fluent representations of speech, along with the original video signals or the replacement video signals, to other participants of the video conference session.

Table 1 below summarizes the various embodiments of the disclosed video conference systems that include FDT capabilities. Each embodiment has advantages and disadvantages relative to the other embodiments with regard to a) ease of software implementation; b) ease of rolling out upgrades (server-based solutions are generally easier to upgrade compared to client-based solutions); c) operating cost (there are significant economies of scale for services that provide text-to-speech functionality that would be realized in a server-based implementation); d) user preferences for text-based versus cloned-audio presentation of the user's original speech; e) user preferences for the video presentation of the user (static picture, avatar, or real-time video); and f) latency, i.e., time gaps between movements in video of a user's speaking lips and the presentation of the text or cloned audio associated with the user's original speech.

TABLE 1
Summary of Disclosed FDT-enabled Video Conference Systems

| Video | FDT- | | | | | | Voice |
|---|---|---|---|---|---|---|---|
| conference | enabled | | | | | | clone |
| system | component | Component | Audio | Video | | Lip/audio | module |
| reference | reference | type | out | out | Latency | sync | location |
| 200 | 50, 290 | client + | none | original | small | fair | local |
| | | server | | video + | | | |
| | | | | STT | | | |
| 300 | 50, 390 | client + | STT/TTS | static | large | NR | local |
| | | server | | image | | | |
| 400 | 50, 490 | client + | STT/TTS | avatar | large | excellent | local |
| | | server | | | | | |
| 500 | 50, 590 | client + | STT/TTS | original | large | poor | local |
| | | server | | video | | | |
| 600 | 50, 690 | client + | STS | original | medium | poor | local |
| | | server | | video | | | |
| 700 | 50, 790 | client + | STT/TTS | original | large | poor | local |
| | | server | | video + | | | |
| | | | | STT | | | |
| 800 | 890 | client | none | original | small | fair | local |
| | | | | video + | | | |
| | | | | STT | | | |
| 900 | 990 | client | STT/TTS | static | large | NR | local |
| | | | | image | | | |
| 1000 | 1090 | client | STT/TTS | static | large | NR | remote |
| | | | | image | | | |
| 1100 | 1190 | client | STT/TTS | avatar | large | excellent | local |
| 1200 | 1290 | client | STT/TTS | original | large | poor | local |
| | | | | video | | | |
| 1300 | 1390 | client | STT/TTS | original | large | poor | local |
| | | | | video + | | | |
| | | | | STT | | | |
| 1500 | 1590 | custom | STT/TTS | original | large | poor | local |
| | | browser | | video + | | | |
| | | client | | STT | | | |

More detail for Table 1 is as follows. The column Video conference system reference includes the reference numeral of each disclosed video conference system embodiment. The column FDT-enabled component reference includes the reference numeral of the component(s) in each video conference system that includes or otherwise incorporates FDT support, while the Component type column includes the type of the FDT-enabled component: video conference server, video conference client, or custom web browser client. For the video conference systems 200 through 700, most of the FDT-enabled capability is implemented in a modified video conference server, with some of the FDT-enabled capability also being implemented in a modified video conference client. In the video conference systems 800 through 1300, all of the FDT-enabled capability is implemented in a modified video conference client, which connects to and communicates with a standard video conference server. The video conference system 1500 in contrast, implements all of its FDT-enabled capability in a custom web browser client, and is configured to operate with standard video conference clients and a standard video conference server.

The Audio out column refers to the audio signal that each FDT-enabled component creates, with the following values: none; STT/TTS, which refers to a transcribed text representation of the user speech (STT), followed by a synthetic audio signal of the transcribed text (TTS); and STS, which refers to synthetic audio signals of the user speech, created directly from the user speech, without an intermediate step of first creating transcribed text from the original audio of the user speech.

The Latency column has values of small, medium and large to indicate the relative delay between the time of the user speech, and the time at which the Audio out signal is created and transmitted to other participants in the video conference session. The Video out column has values of original video, original video+STT, static image, and avatar, and refers to different video representations of the user. The Lip/audio sync column refers to how well the lip movements in the Video out signal are synchronized with the Audio out signal. Values for this column include: poor, fair, not relevant (NR) and excellent.

Finally, the Voice clone module location column has values of local or remote and refers to the location of an audio clone software module relative to the video conference server or video conference client. Here, “local” indicates that the module can either reside within or be locally accessible to the video conference server or video conference client, while “remote” indicates that the module is located remote to the video conference server or video conference client, such as being included within or hosted by a remote service, such as a software as a service. The estimates of latency and lip sync in Table 1 are based on technology available in 2025, and it is expected that both latency and lip sync will improve over time as these technologies evolve.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIGS. 1A-1C are schematic diagrams of different voice clone software modules that can reside in either a video conference server, a video conference client, or a voice clone server;

FIG. 1D is a schematic diagram of a typical standard video conference program that includes a video conference client and a video conference server;

FIG. 1E is a schematic diagram of an FDT-compatible video conference client that is used in the disclosed video conference systems of FIGS. 2-7;

FIG. 1F is an exemplary software code snippet of user configuration data that the disclosed video conference system embodiments can use to configure the video conference systems;

FIG. 2 is a schematic diagram of a video conference system, according to an embodiment, that includes a FDT video conference server and FDT-compatible video conference clients in accordance with FIG. 1E, where the FDT video conference server: 1) establishes a video conference session between a stuttering user and other session participants; 2) receives original audio user speech and original video of the stuttering user, sent from the FDT-compatible video conference client of the user, the original audio including disfluent speech; 3) transcribes the original audio user speech into a text-based fluent representation of speech; 4) superimposes the fluent text onto the original video signals of the user to create a composite signal; and 5) forwards the composite signal to the other participants;

FIG. 3 is a schematic diagram of a video conference system as in FIG. 2, according to an embodiment, where the FDT video conference server is configured to clone the original audio user speech into fluent synthetic speech and to represent the user visually by a static image;

FIG. 4 is a schematic diagram of a video conference system as in FIGS. 2-3, according to an embodiment, where the FDT video conference server is configured to clone the original audio user speech into fluent synthetic speech and to represent the user visually by an animated avatar whose lip movements might be informed by the fluent synthetic speech;

FIG. 5 is a schematic diagram of a video conference system as in FIGS. 2-4, according to an embodiment, where the FDT video conference server is configured to clone the original audio user speech into fluent synthetic speech and to represent the user visually by the original video signals;

FIG. 6 is a schematic diagram of a video conference system as in FIGS. 2-5, according to an embodiment, where the FDT video conference server is configured to clone the original audio user speech directly into fluent synthetic speech and to represent the user visually by the original video signals;

FIG. 7 is a schematic diagram of a video conference system, according to an embodiment, where the FDT video conference server clones the original user speech into fluent synthetic speech and represents the user visually by the original video signals, and where a fluent transcription of user speech is superimposed onto the original video;

FIG. 8 is a schematic diagram of a video conference system, according to an embodiment, that includes a proposed FDT video conference client in communication with a standard video conference server, where the FDT video conference server establishes a video conference session between the FDT video conference client of the stuttering user and video conference clients of other session participants, and where the FDT video conference client: 1) receives original audio from the stuttering user, via a microphone, and receives original video of the user from a video camera; 2) creates a text-based fluent representation of the user speech from the original audio; 3) superimposes the fluent text onto the original video to form a composite signal; and 4) sends the composite signal to a standard video conference server, which forwards the composite signal to the other session participants;

FIG. 9 is a schematic diagram of a video conference system as in FIG. 8, according to an embodiment, where the FDT video conference client clones the original audio user speech into fluent synthetic speech and represents the user visually by a static image;

FIG. 10 is a schematic diagram of a video conference system as in FIGS. 8-9, according to an embodiment, where the FDT client clones user speech into fluent synthetic speech, represents the user visually by a static image, and uses a separate voice clone service server computer to generate the fluent synthetic speech;

FIG. 11 is a schematic diagram of a video conference system as in FIGS. 8-10, according to another embodiment, where the FDT video conference client clones user speech into fluent synthetic speech, and represents the user visually by an animated avatar whose lip movements might be informed by the fluent synthetic speech;

FIG. 12 is a schematic diagram of a video conference system as in FIGS. 8-11, according to another embodiment, where the FDT video conference client clones user speech into fluent synthetic speech, and represents the user visually by the original video;

FIG. 13 is a schematic diagram of yet another video conference system that includes an FDT video conference client, where the FDT video conference client clones user speech into fluent synthetic speech, represents the user visually by a video signal captured by the video camera, and superimposes fluent text onto the video signal;

FIG. 14 illustrates an exemplary configuration screen of a client graphical user interface (client GUI) included in the video conference systems of FIGS. 2 through 13, where a disfluent participant can use the client GUI to modify user configuration data;

FIG. 15 is a schematic diagram of an alternative web browser-based client application that has been modified to create fluent representations of user speech, also known as an FDT-enabled web browser, which transcribes the original audio user speech of the stuttering user into a fluent text-based representation, and which superimposes the fluent text-based transcription of the user speech onto original video of the stuttering user to create a composite video signal, where the FDT-enabled web browser further synthesizes the text-based transcription into fluent synthetic speech, transmits the fluent synthetic speech into a website-requested microphone input port of a video conference client of a standard video conference program, and transmits the composite video signal into a website-requested webcam input port of the video conference client;

FIG. 16 is a flowchart that describes a method for an FDT video conference server, where the FDT video conference server can be any of the disclosed FDT video conference server embodiments; and

FIG. 17 is a flowchart that describes a method for an FDT video conference client, where the FDT video conference client can be any of the disclosed FDT video conference client embodiments.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

It will be understood that although terms such as “first” and “second” are used herein to describe various elements, these elements should not be limited by these terms. These terms are only used to distinguish one element from another element. Thus, an element discussed below could be termed a second element, and similarly, a second element may be termed a first element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Per Jackson 2021, a stuttering user should be alone and not within earshot of other people when speaking during video conference sessions in the embodiments of the proposed video conference system. Otherwise, the benefits that the system provides to stuttering users is limited. At the same time, the fluency of the stutterers' speech will be considerably improved during the video conference sessions because the users' original speech is also not transmitted to the other participants in the session, so they are effectively ‘speaking while alone’.

Commercial video conference programs such as Zoom, Google Meet, Webex and Microsoft Teams offer a wide range of services including: making a recording of the video conference session; summarizing the session; muting particular users or all but one user; implementing a “waiting room” for users who must then be manually allowed into the session by a moderator; using an avatar to represent users; billing; scheduling video conference sessions; control over how the participants' video is displayed (e.g. ‘speaker’ versus ‘audience’ view); and managing many users simultaneously (possibly thousands). However, these services themselves are tangential to how they might be modified to transmit fluent representations of user speech, as described in the disclosed embodiments, and for this reason they are not shown in the figures.

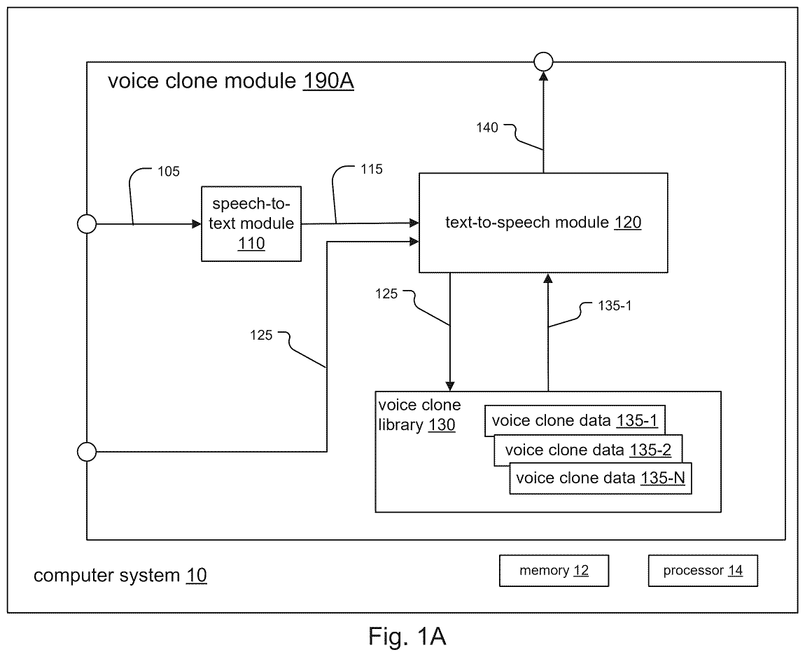

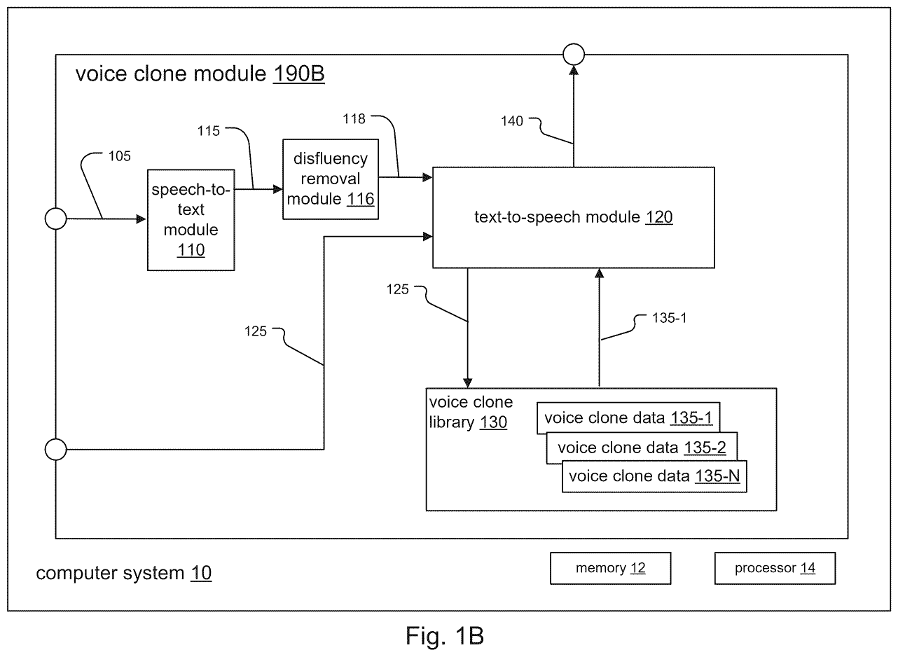

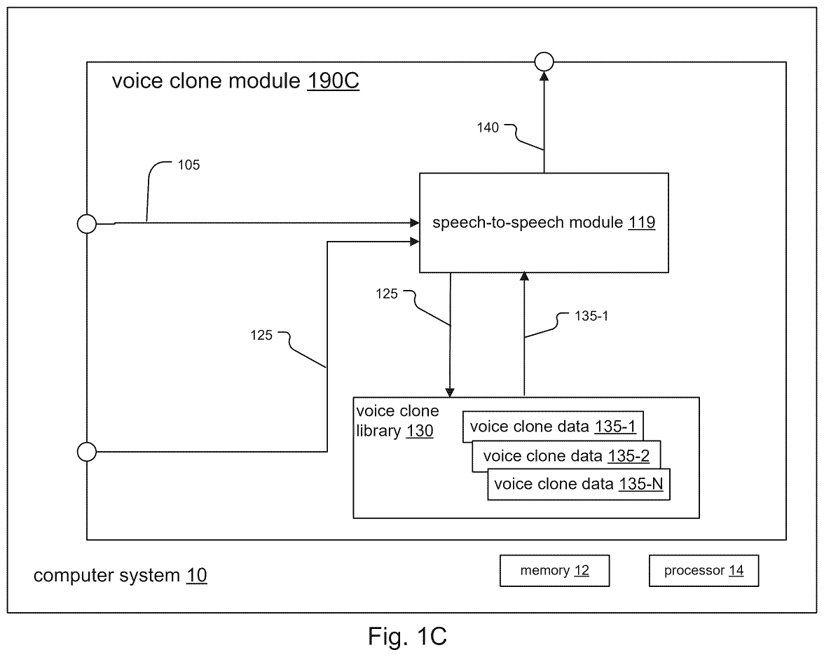

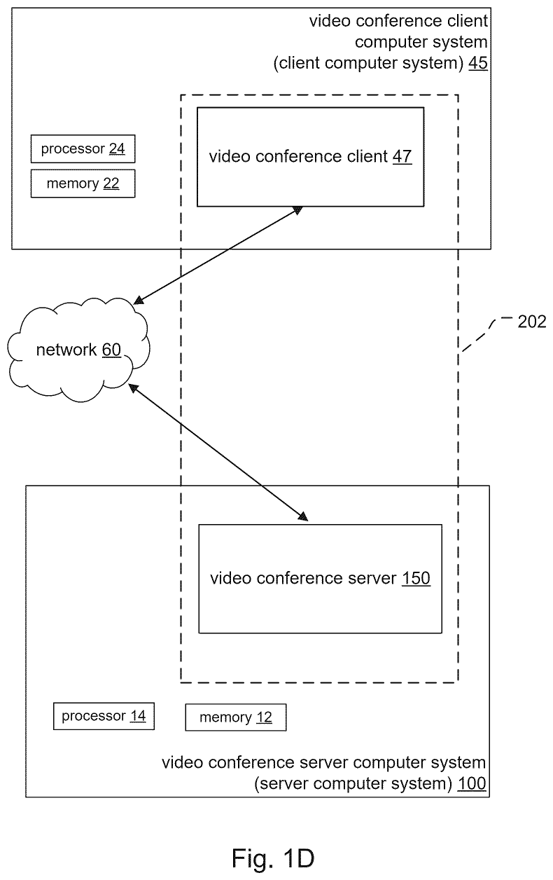

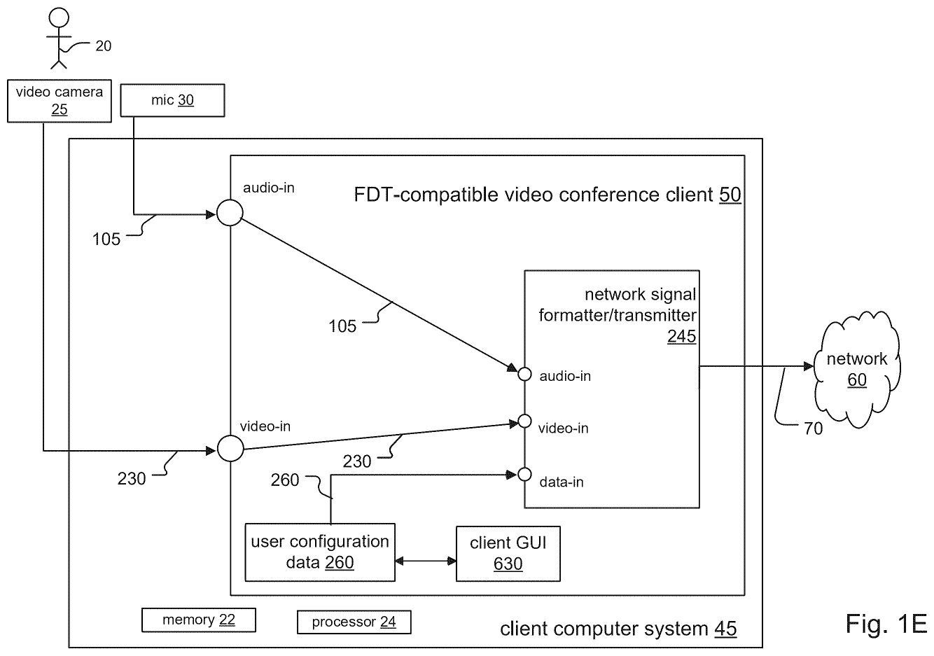

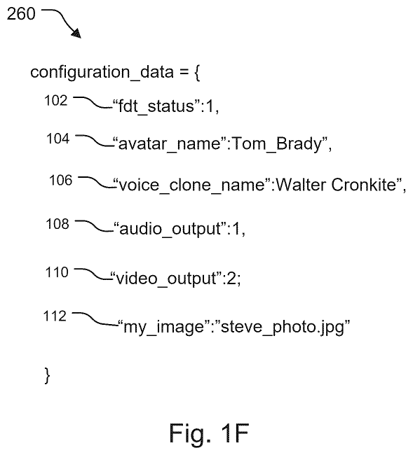

FIGS. 1A, 1B and 1C respectively show different software voice clone modules 190A, 190B and 190C that can be used in the disclosed FDT-enhanced video conference systems.

In FIG. 1A, the voice clone module 190A executes upon a computer system 10, such as a video conference server, a video client computer or a voice clone server, in examples. The computer system 10 includes a processor 14 and a memory 12.

The voice clone module 190A is one example of existing commercial voice clone systems and is shown for only completeness, because several embodiments of the FDT video conference server and the FDT video conference client employ voice clone modules. The voice clone module 190A includes a speech-to-text module 110, a text-to-speech module 120 and a voice clone library 130. The voice clone library 130 includes voice clone parametric data (voice clone data 135) of one or more different individuals, where the voice clone data is derived from audio recordings of those individuals. Multiple instances of voice clone data 135-1 . . . 135-N for one or more individuals are shown.

The voice clone module 190A generally operates as follows. The module 190A accepts, as input, an audio signal 105 representing user speech and receives a request message for a specific instance of voice clone data 135 for an individual (voice clone request) 125. The module 190A forwards the audio signal 105 to the speech-to-text module 110 and forwards the voice clone request 125 to the text-to-speech module 120.

The speech-to-text module 110 receives the input audio signal 105 and generates transcribed text 115 in response. The transcribed text 115 is then sent to the text-to-speech module 120. The text-to-speech module 120 receives the transcribed text 115 and the voice clone request 125 as inputs, and transmits the voice clone request 125 to the voice clone library 130. The library 130 returns the voice clone data 135 in response. Here, a specific instance of voice clone data 135-1, returned by the voice clone library 130, is shown.

The text-to-speech module 120 then applies text-to-speech algorithms to the input transcribed text 115, and using the voice clone data 135-1, generates an output fluent synthetic speech 140 audio signal in response. The fluent synthetic speech 140 includes a vocalized representation of words in the transcribed text 115, expressed in the voice of the voice clone data 135-1. The voice clone module 190A then provides the fluent synthetic speech 140 as output.

In a preferred embodiment, the voice clone library 130 may include voice clone data 135 of various stock voices such as the voices of professional radio and TV newspeople, movie stars, and historical figures, in examples. In addition, the voice clone library 130 can include voice clone data 135 that mimics the voice of the user.

It can also be appreciated that the voice clone library 130 can be located outside of the voice clone module 190A, such as in a database that is in communication with the module 190A.

FIG. 1B shows another voice clone module 190B. The module 190B includes substantially the same components and operates in a substantially similar way as the voice clone module 190A. However, there are differences. The voice clone module 190B additionally includes a disfluency removal module 116. The disfluency removal module 116 receives transcribed text 115 as input and generates fluent text 118 as output. The disfluency removal module 116 removes most, if not all, disfluent text representations of speech from the transcribed text 115 when generating the fluent text 118.

Instead of the text-to-speech module 120 receiving transcribed text 115 as input from the speech-to-text module 110, as in the voice clone module 190A of FIG. 1A, the text-to-speech module 120 receives the fluent text 118 as input, sent from the disfluency removal module 116. The text-to-speech module 120 generates the output fluent synthetic speech 140 from the input fluent text 118, expressed in the voice of the voice clone data 135-1 obtained from the voice clone library 130.

FIG. 1C includes yet another voice clone module 190C. The voice clone module 190C has substantially the same components, and operates in a substantially similar way, as the voice clone module 190A of FIG. 1A. However, the voice clone module 190C replaces the speech-to-text-module 110 and text-to-speech-module 120 of FIG. 1A with a speech-to-speech module 119 that provides the same functionality.

At present, voice clone technology, such as that provided by the voice clone modules 190A-C, can generate realistic fluent synthetic speech 140 from input text and at low cost. However, the processing speed is such that there may be a temporal lag, or latency, of a few seconds between the arrival of the input text stream and the generation of the corresponding fluent synthetic speech 140. It is expected that the latency may be reduced considerably in the near future as the underlying technologies evolve.

FIG. 1D shows a simplified version of a typical, standard video conference program 202. The video conference program 202 includes a video conference client 47 and a video conference server 150. The video conference client 47 is included within and is hosted by a video conference client computer system, also known as a client computer system 45. The client computer system 45 also includes a processor 24 and a memory 22. The video conference server 150 is included within and is hosted by a video conference server computer system, also known as a server computer system 100. The server computer system 100 also includes a processor 14 and a memory 12.

The video conference client 47 and the video conference server 150 each connect to and communicate over a network 60. In examples, the network can be a public network such as the Internet, or a private network.

The video conference program 202 generally operates as follows. A user at the client computer system 45 accesses the video conference client 47 to initiate a video conference session or join an existing session with one or more remote conversation partners (RCPs). Each of the RCPs similarly use a video conference client on separate client computer systems to similarly initiate or join the video conference session. The RCPs and their client computer systems are not shown in the figure. The video conference server 150 authorizes the user and the RCPs, and establishes the video conference session at the behest of the user and/or the RCPs.

However, the video conference program 202 presents problems for stuttering users/PWS. This is because the video conference client 47 transmits all original user speech to the RCPs via the server 150, and also transmits all original video of the user to the RCPs via the server 150. Because the original user speech includes any disfluencies, and the original video includes any unwanted/repeated facial and/or body movements made by the user during stuttering, fluent conversation between the stuttering user and the RCPs is not possible with standard video conference programs 202.

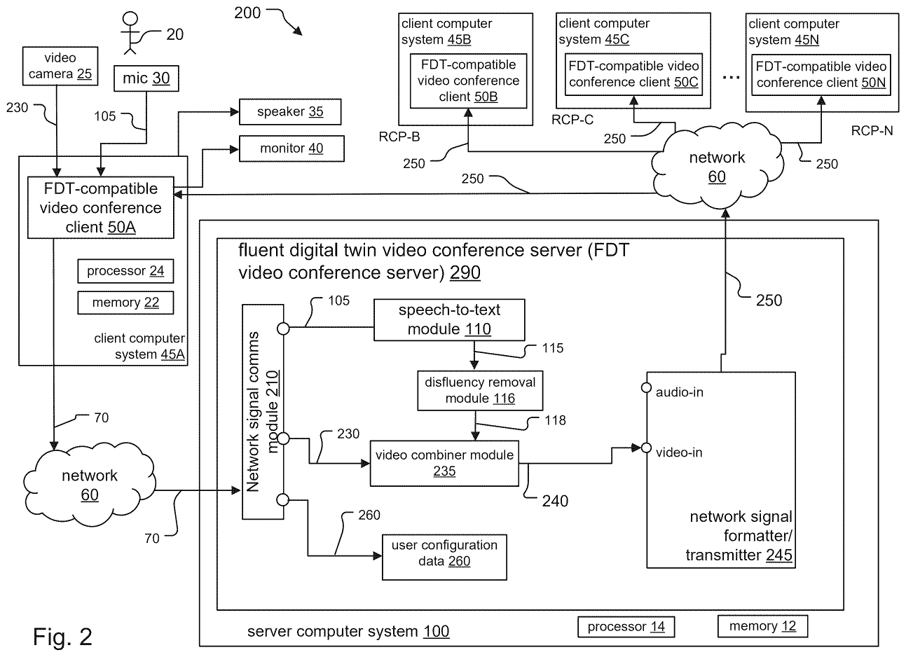

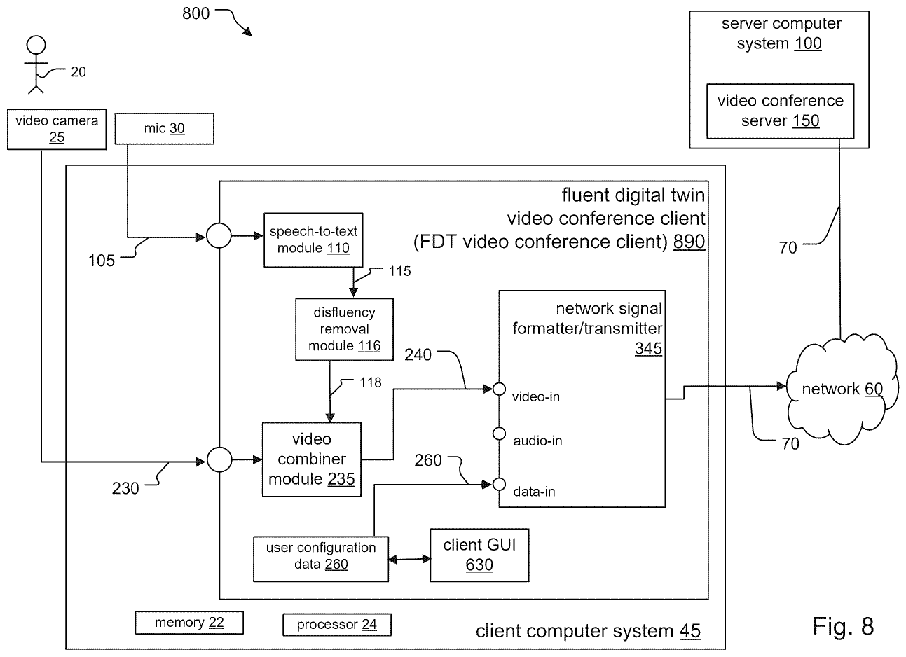

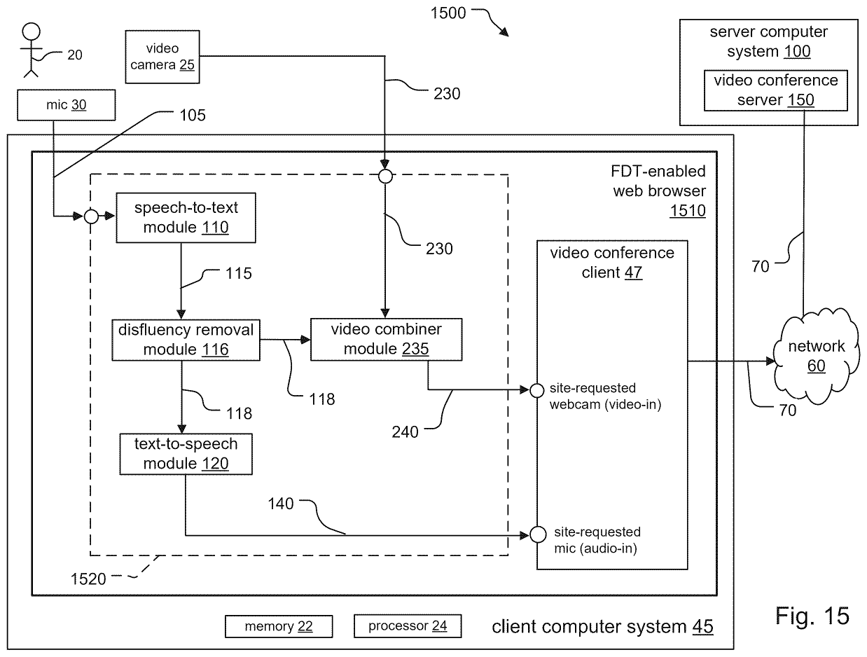

FIGS. 2 through 13 and FIG. 15, the descriptions of which are included hereinbelow, show embodiments of improved video conference systems that enable stuttering users to have fluent conversations with one or more RCPs in video conference sessions. For this purpose, FIGS. 2 through 7 include different FDT video conference servers that each produce fluent representations of speech (audio and/or video) of stuttering users, and transmit the fluent representations of speech to other video conference session participants. FIGS. 8 through 13, in contrast, each include different FDT video conference clients to accomplish the same objective as that performed by the FDT video conference servers in FIGS. 2 through 7. The FDT video conference clients transmit the fluent representations of speech to a standard video conference server, which forwards the fluent representations of speech to the other video conference session participants. In FIG. 15, an FDT-enabled web browser produces fluent representations of speech of a stuttering user, and sends the fluent representations of speech to a standard video conference program 202. Here, the fluent representations of speech are in the form of spoofed audio and video, which the FDT-enabled web browser sends as input to the video conference client of the video conference program.

FIG. 1E shows an FDT-compatible video conference client 50 that is included in the video conference systems of FIGS. 2 through 7. The FDT-compatible video conference client 50 is included within/hosted by a client computer system 45. The client computer system 45 also includes a processor 24 and a memory 22.

Other components connect to or are otherwise in communication with the FDT-compatible video conference client 50. These components include a network 60, a video camera 25 and a microphone (mic) 30. The mic 30 and the video camera 25 connect to audio-in and video-in ports, respectively, of the FDT-compatible video conference client 50. The FDT-compatible video conference client 50 includes user configuration data 260, a client GUI 630 and a network signal formatter/transmitter 245.

Within the FDT-compatible video conference client 50, its audio-in and video-in ports connect to respective audio-in and video-in ports of the network signal formatter/transmitter 245. Output of the network signal formatter/transmitter 245 connects to the network 60. The user configuration data 260 is persistently stored within the FDT-compatible video conference client 50 and includes default values.

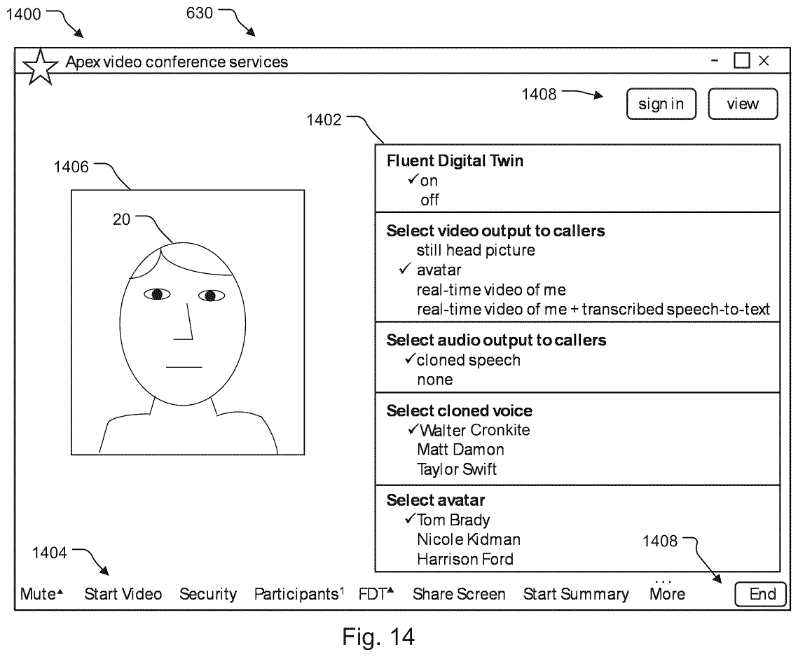

The client GUI 630 stores information to and accesses information from the user configuration data 260, and provides a mechanism for the user to modify the user configuration data 260. An example screen of the client GUI 630 is shown in FIG. 14, the description of which is included hereinbelow.

The FDT-compatible video conference client 50 generally operates as follows. A user 20, such as a stuttering user, speaks into the mic 30, which creates original audio 105 of the user speech. The video camera 25 captures original video 230 of the user 20. The user 20 also accesses the client GUI 630 to modify/update the user configuration data 260. The user configuration data 260 is used to configure the various embodiments of the video conference systems disclosed herein. Then, the FDT-compatible video conference client 50 forwards the audio signal 105, the video signal 230, and the user configuration data 260 to the audio-in, video-in, and data-in ports, respectively, of the network signal formatter/transmitter 245.

The network signal formatter/transmitter 245 combines the original audio 105, the original video 230 and the user configuration data 260 into a network-compatible signal 70, and transmits the signal 70 via the network 60 to other components (not shown) in communication with the network 60.

Until the user 20 accesses the client GUI 630 to modify/update the user configuration data 260, the FDT-compatible video conference client 50/network signal formatter/transmitter 245 uses the stored version of the user configuration data 260. The network signal formatter/transmitter 245 combines the user configuration data 260, along with new original audio 105 and new original video 230, into the network-compatible signal 70.

FIG. 1F shows detail for an exemplary implementation of the user configuration data 260, in the Python programming language. In the illustrated example, the user configuration data 260 includes keyword-value pairs. Keyword-value pairs 102, 104, 106, 108, 110 and 112 are shown. Each of the values of the keyword-value pairs has a default value. Table 2 summarizes the keyword-value pairs in the exemplary instance of user configuration data 260 shown in FIG. 1F.

Via a graphical user interface, a user of the video conference systems can modify the values of the keyword-value pairs to configure and update the video conference systems disclosed herein. For the video conference systems of FIGS. 2 through 7, in examples, the user modifies the user configuration data 260 via the client GUI 630 of the FDT-compatible video conference client 50 of FIG. 1E.

TABLE 2
Summary of exemplary user configuration data in FIG. 1F

| Keyword- | | | | |
|---|---|---|---|---|
| value | | | | |
| pair | Keyword | | | |
| reference | name | Current value | Exemplary values | Description |
| 102 | fdt_status | 1 | 1 = on, 0 = off | toggles state of FDT |
| | | | | capability |
| 104 | avatar_ name | “Tom_Brady” | n/a | avatar descriptor |
| 106 | voice_clone_name | “Walter_Cronkite” | n/a | voice clone |
| | | | | descriptor |
| 108 | audio_output | 1 | 1 = cloned speech, | enable/disable |
| | | | 0 = none | cloned speech |
| | | | | capability |
| 110 | video_output | 2 | 0 = none, 1 = still | select which type of |
| | | | image, 2 = avatar, | visual representation |
| | | | 3 = original video, 4 = | of user |
| | | | composite signal | |
| | | | (video with | |
| | | | superimposed fluent | |
| | | | transcribed text) | |
| 112 | my_image | “steve_photo.jpg” | n/a | still image descriptor |

In examples, the value for the avatar_name keyword in the keyword-value pair 104 is an avatar descriptor that identifies an avatar that the user 20 selects to provide a replacement visual representation of the user 20. Similarly, the value for the voice_clone_name keyword in the keyword-value pair 106 is a voice clone descriptor that identifies a voice of a selected individual to use as a replacement voice of the user 20. Additionally, the value for the my_image keyword in the keyword-value pair 112 is an image descriptor that identifies a static image of a selected individual to use as a replacement visual representation of the user 20. The value for the my_image keyword is a filename for a static image.

FIG. 2 shows a preferred embodiment of a FDT video conference server 290 in a video conference system 200. The video conference system 200 includes the FDT video conference server 290 and includes components of video conference systems. These components include one or more FDT-compatible video conference clients 50A, 50B, 50C, . . . 50N that communicate with the FDT video conference server 290 over communications network 60. Each of the FDT-compatible video conference clients 50A, 50B, 50C, . . . 50N are included within separate client computer systems 45A, 45B, 45C . . . 45N, respectively. Each of the FDT-compatible video conference clients 50 are software components that execute on/are hosted by their respective client computer systems 45. Some detail for client computer system 45A is shown.

The FDT video conference server 290 executes on a server computer system 100. The server computer system 100 includes a processor 14 and a memory 12. The FDT video conference server 290 includes a network signal communications module (network signal comms module) 210, a speech-to-text module 110, a video combiner module 235, user configuration data 260 and a network signal formatter/transmitter module 245. The FDT video conference server 290 might also include a disfluency removal module 116. The FDT video conference server 290 establishes video conference sessions that include the user 20 and other participants

The FDT video conference server 290 receives, as input, audio signals 105 and video signals 230 of a stuttering user 20 during a video conference session. The FDT video conference server 290 generates or otherwise produces fluent text 118 from the audio signals 105, and superimposes the fluent text 118 onto the user video signal 230 to create a composite video signal 240. The FDT video conference server 290 then forwards a network-compatible version of the composite video signal, also known as a network-compatible signal 250, to one or more video conference participants.

The video conference system 200 generally operates as follows. At the FDT-compatible video conference client 50A, the user 20, via the client GUI 630, configures the one or more of the keyword-value pairs in the user configuration data 260. Speech of the user 20 is captured by the microphone 30 and represented as audio signals, also known as original audio signals 105, and video of the user is captured by the video camera 25 and represented as video signals, also known as original video signals 230. The FDT-compatible video conference client 50A creates a network-compatible signal 70 which includes the original audio signals 105, the original video signals 230 and the user configuration data 260, and transmits the network-compatible signal 70 over the communications network 60 to the FDT video conference server 290.

At the FDT video conference server 290, the network compatible signal 70 is received by the network signal comms module 210 of the FDT video conference server 290. The network signal comms module 210 separates the signal 70 into three separate components: an audio signal 105, a video signal 230 and the user configuration data 260. The audio signal 105 is an audio signal representation of the user speech, the video signal 230 includes video images of the user as captured by the video camera 25, and the user configuration data 260 defines user-selected options. The user-selected options control various features of a user's video conference experience, such as whether to display images of multiple call participants in a group (e.g., ‘gallery’) or individual (e.g., ‘speaker’) format, and various configuration options for the fluent representations of user speech and video of the user.

The network signal comms module 210 transmits the audio signal 105 to the speech-to-text module 110, which receives the audio signal as input and generates a stream of transcribed text 115 as output. The transcribed text 115 includes words that the speech-to-text module 110 identifies in the audio signal 105. The speech-to-text processing performed by the speech-to-text module 110 typically removes some, but not all, of disfluent utterances that are present in the input audio signal 105. As a result, the transcribed text 115 that is generated by speech-to-text module 110 is more fluent than the speech in the input audio signal 105.

The disfluency removal module 116 has artificial intelligence (AI) capabilities including natural language processing (NLP) and is configured or otherwise trained to remove disfluencies in input text. The module 116 receives the transcribed text 115 as input, along with at least one input prompt (not shown), also known as a command. The command might include instructions to remove unnecessary duplicated words and filler words, also known as discourse markers. Examples of the discourse markers include “um,” “ah,” “you know,” and “like.”

The disfluency removal module 116 receives the input transcribed text 115 and command, removes nearly all remaining disfluencies in the transcribed text 115, and generates fluent text 118 as output. The fluent text 118 and the video signal 230 are then transmitted to the video combiner module 235. The video combiner module 235 receives the inputs 118 and 230 and creates a new, composite video signal 240 as output. The composite video signal 240 superimposes the fluent text 118 directly on the video signal 230. This text is superimposed onto the user's video signal.

The user configuration data 260 is stored as static data in the memory 12. The user configuration data 260 are used by the FDT video conference server 290 to control various features of the user video conference experience.

The network signal formatter/transmitter module 245 has an audio-in port and a video-in port. The output of the video combiner module 235 connects to the video-in port of the network signal formatter/transmitter module 245. The video combiner module 235 transmits the composite video signal 240 to the network signal formatter/transmitter module 245 via its video-in port. The network signal formatter/transmitter module 245 converts the video signal 240 into a network-compatible signal 250, which is transmitted to the video conference client 50 of each user over the network 60. The video conference client 50 then displays the composite video signal 240 on the user's monitor 40. It is important to note that while the network module 245 has an input audio-in port for an audio signal, no audio signal is transmitted to the network module 245 in this embodiment. The user 20 will effectively be ‘muted’ to all participants in the video conference session.

The network-compatible signal 250 can also be transmitted to multiple participants/RCPs in the video conference session. Each participant/RCP, listed as RCP-B, RCP-C . . . . RCP-N, joins the session via FDT-compatible video conference clients 50B, 50C, . . . 50N, respectively. FIGS. 2-5 show the transmission of the same network-compatible signal 250 to all participants in the video conference session, but this is shown to convey only that the same information content of the network-compatible signal 250 (audio and video) that pertains to the stuttering user 20 is forwarded to all video conference session participants.

It can also be appreciated that the composite video content of the network-compatible signals 250 may differ depending on how individual participants configured their video conference experience, via the user configuration data 260. For example, some users may request a ‘gallery’ view of all participants, while other users may request a speaker-centric view that displays video images of only the current speaking participant.

One or more embodiments of a FDT video conference server described in FIGS. 2 through 7 could be present on the same server computer system 100 simultaneously. If more than one embodiment of an FDT video conference server is implemented and available for use on a server computer system 100, then the user configuration data 260, for one or more users 20, will include data that specifies which of the embodiments is to be activated for the current video conference session. For this purpose, the server computer system 100 reads the user configuration data 260, and instructs the processor 14 to execute object code of the FDT video conference server(s) specified in the user configuration data 260 to activate the FDT video conference server(s) for the current video conference session.

In summary, the FDT video conference server 290 conveys words spoken by a stuttering user 20, as text, to participants in a video conference session, without transmitting the user's actual audible speech to the participants. The FDT video conference server 290 excludes, or otherwise filters, the stuttering user's disfluent utterances from the information that the FDT video conference server 290 sends to the participants. It is well known from stuttering research that PWS are remarkably more fluent when alone than when in the presence of other people (in-person or remote). As a result, the speech fluency of the user 20 in the ‘speaking while alone’ environment provided by the FDT video conference server 290 is expected to be much better than it normally would be in the presence of other participants. In addition, if the speech-to-text module 110 is based on large language models, some or all of the residual disfluencies in the user's speech will be ‘erased’, i.e., many of the disfluent utterances will not be transcribed, and thus will not be included in the transcribed text stream 115. Correspondingly, many of the disfluent utterances will not be included in the resultant composite video signal 240. Thus, the FDT video conference server 290 facilitates fluent communication by an otherwise stuttering user during video conference sessions with other participants.

It will be appreciated that, in the foreseeable future, given the rapid pace of innovation in software-based speech processing, the transcription of audio signal 105 by the speech-to-text module 110 may remove all disfluent utterances. Here, the transcribed text stream 115 would be fully fluent and no postprocessing would be required by a disfluency removal module 116; the transcription 115 could be piped directly into the video combiner module 235.

It can also be appreciated that the video conference system 200 can provide fluent representations of speech of multiple stuttering users 20 during a video conference session. For this purpose, each stuttering user 20 uses an associated FDT-compatible video conference client 50 to create user configuration data 260 that is specific to each user 20. The FDT video conference server 290 creates fluent representations of speech for each stuttering user 20, from at least the original audio 105 of each user 20 and based upon the user configuration data 260 of each stuttering user 20.

Moreover, the video conference system 200 is also compatible with standard video conference clients 47. The FDT video conference server 290 transmits the same network-compatible signal 250 to all participants of the video conference session, whether the participants use standard video conference clients 47 or the FDT-compatible video conference clients 50.

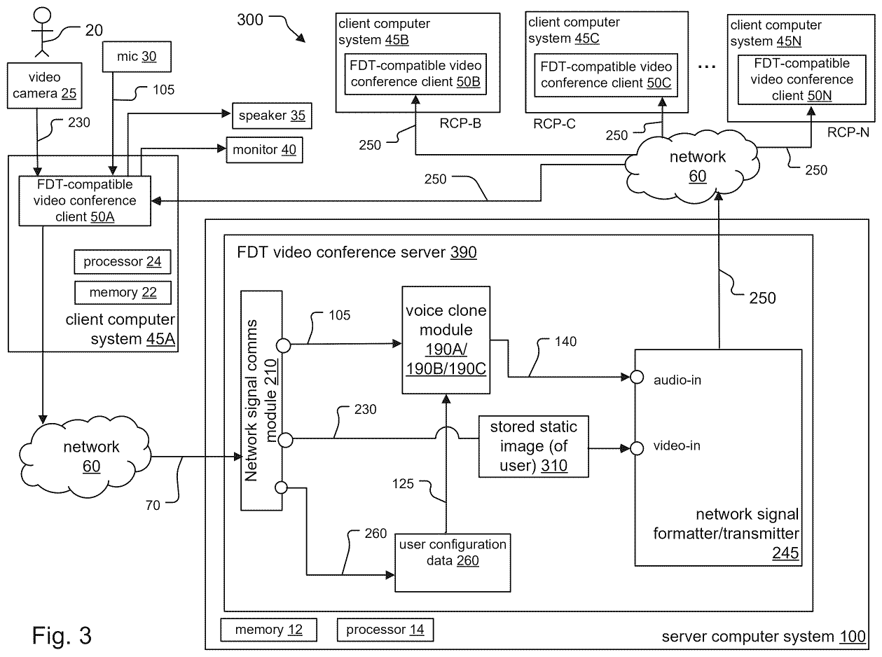

FIG. 3 is a schematic diagram of a video conference system 300 that includes an FDT video conference server 390. The FDT video conference server 390 clones an input audio signal 105 that represents user speech into fluent synthetic speech 140. The FDT video conference server 390 represents the user visually by a static image 310.

The video conference system 300 has substantially similar components and is arranged in a substantially similar way as in the video conference system 200 of FIG. 2. However, there are differences. Like the FDT video conference server 290, the FDT video conference server 390 includes the network signal comms module 210, the user configuration dataset 260 and the network signal formatter/transmitter 245. However, the FDT video conference server 390 effectively replaces the video combiner module 235 of the FDT video conference server 290 with a voice clone module 190. Note that any of the voice clone modules 190A, 190B or 190C can be deployed.

Output ports of the network signal comms module 210 connect to the input of the voice clone module 190, and to a storage mechanism, such as the memory 12, to store a static image 310 of the user (possibly extracted from the video signal 230), and to store the user configuration data 260. The output of the voice clone module 190 connects to the audio-in port of the network signal formatter/transmitter module 245. As with the FDT video conference server 290, the FDT video conference server 390 excludes or otherwise filters the audio of the user's original spoken words from the information that the FDT video conference server 390 forwards to the other participants in the video conference session.

The FDT video conference server 390 has an advantage and one or more disadvantages compared to the FDT video conference server 290. The FDT video conference server 390 offers the advantage that information contained in the user's speech (here, in the form of the fluent synthetic speech 140) is conveyed to video conference session participants audibly, rather than visually (as text) as in the FDT video conference server 290. Communicating the information in user speech via an audio signal as in the FDT video conference server 390 is the default implementation in standard video conference sessions and will seem more natural to the session participants. However, the FDT video conference server 390 has a disadvantage in that it represents the user visually only as a static picture image, which is less engaging than the video images employed in the FDT video conference server 290. In addition, depending on implementation details, there may be a greater lag time between the user speech and the reconstructed fluent speech, in the FDT video conference server 390, than the lag time between the user speech and the fluent transcribed text that is superimposed on the user's outgoing video signal, in the FDT video conference server 290.

The video conference system 300 generally operates as follows. At the FDT video conference server 390, the network signal comms module 210 first separates the incoming network compatible signal 70, sent from the FDT-compatible video conference client 50A, into three separate components: an audio signal 105, a video signal 230, and the user configuration data 260. As in FIG. 2, the audio signal 105 contains the audio signal representation of the user speech, the video signal 230 contains the video images of the user as captured by the video camera 25 or a static image of the user, and the user configuration data 260 includes information that defines user-selected options.

The network signal comms module 210 transmits the audio signal 105 as input to the voice clone module 190 and updates the local copy of the user configuration data 260 with the received version from the network compatible signal 70. The FDT video conference server 390 creates a voice clone request message, or voice clone request 125, and includes the value of the keyword-value pair 106 from the user configuration data 260 as a parameter in the request 125. The value is a voice clone descriptor. The FDT video conference server 390 then sends the request 125 to the voice clone module 190.

The voice clone module 190 receives the voice clone request 125, and in response, obtains an instance of voice clone data 135 associated with the voice clone descriptor from the voice clone library 130. The voice clone module 190 generates fluent synthetic speech 140 from the original audio signals 105, based on the voice clone data 135. The fluent synthetic speech 140 contains fluent versions of the same or very similar words as the audio signal 105, but is articulated in the specified ‘voice’ of the voice clone data 135. Typically, the fluent synthetic speech 140 is generated to resemble speech of professional voice actors such as television or radio hosts and broadcasters. However, the fluent synthetic speech 140 might also be generated to resemble that of the user 20.

The voice clone module 190 then transmits the fluent synthetic speech 140 to the audio-in port of the network signal/formatter module 245. The FDT video conference server 390, in one example, saves a single frame of the video signal 230 to the memory 12 as a stored static image 310 of the user, and transmits the stored static image 310 to the network signal formatter/transmitter module 245 via its video-in port. The static image 310 might also be provided by the user 20, included in the user configuration data 260 as the value for the keyword-value pair 112. The network signal formatter/transmitter module 245 combines the fluent synthetic speech 140 and the static image 310 into a combined signal, and formats the combined signal into a network compatible format, thereby forming the network-compatible signal 250. The network-compatible signal 250 is then transmitted by the module 245 over the network 60 to the FDT-compatible video client applications 50A, 50B, 50C, . . . 50N. The FDT-compatible video client applications 50 then separate the network-compatible signal 250 back into audio and video signals, which are respectively presented to each user via the speaker 35 and the monitor 40 associated with each user 20.

In summary, the FDT video conference server 390 converts words spoken by a stuttering user 20 into fluent synthetic speech 140, and transmits the fluent synthetic speech 140 to participants in a video conference session, without transmitting the original audio signals 105/the user's actual audible speech, to the session participants. Thus, the user remains in a ‘speaking-while-alone’ conversational environment which is known to promote fluency in people who stutter. In addition, if the text-to-speech module 110 of the voice clone module 190 is based on large language models (LLMs), experimentation has shown that many of the disfluencies in the user's speech will be ‘erased’, i.e., these disfluent utterances will not be included in the transcribed text 115. The residual disfluencies in the transcribed text 115 can optionally be removed by including the disfluency removal module 116 shown in FIG. 2.

As a result, disfluencies will not be present in the fluent synthetic speech 140 of the user 20 that the FDT video conference server 390 sends to the other session participants. Thus, the FDT video conference server 390 facilitates fluent communication by an otherwise stuttering user during video conference sessions with other participants.

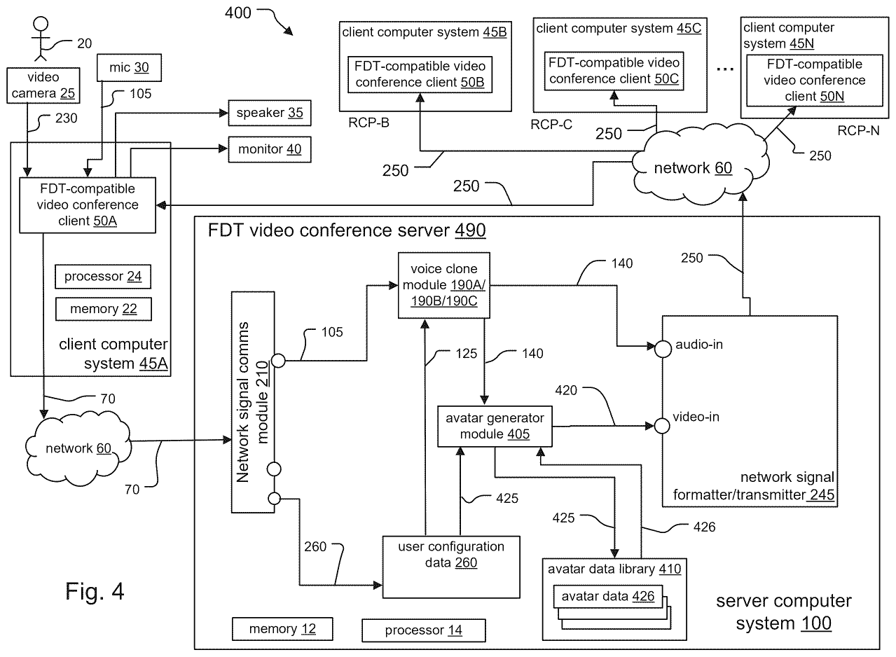

FIG. 4 is a schematic diagram of another video conference system 400. The video conference system 400 includes an FDT video conference server 490 that clones user speech into fluent synthetic speech 140, and represents the user visually by an animated avatar. The video conference system 400 has substantially similar components and is arranged in a substantially similar way as in the video conference system 300 of FIG. 3. However, there are differences. Like the FDT video conference server 390, the FDT video conference server 490 includes the network signal comms module 210, the user configuration data 260, the voice clone module 190 and the network signal formatter/transmitter 245. In contrast, the FDT video conference server 490 also includes an avatar generator module 405 and an avatar data library 410. Parametric data that characterize one or more avatars, also known as avatar data 426, is stored in the avatar data library 410.

The FDT video conference server 490 also differs from the FDT video conference server 390 in how the user is represented visually to participants in the video conference session. In the FDT video conference server 390, the user 20 is represented visually by a static image 310, whereas in the FDT video conference server 490, the user 20 is represented visually by an animated avatar, the latter of which may or may not be constructed to resemble the user's true visage. Some stutterers may prefer that their visual image be represented by an avatar rather than video, because if they do stutter, their video would capture their stuttering ‘struggle behaviors” such as tremors of the lips, which they would not want to share with their RCPs, even if their cloned speech was fluent.

At the FDT video conference server 490, the initial processing of the incoming network signal 70 is substantially the same as in FIG. 3: the network signal comms module 210 separates the signal 70 into an audio signal 105, a video signal 230 and user configuration data 260. Processing of the audio signal 105 is also the same as in the video conference system 300 of FIG. 3: the audio signal 105 is transmitted to the voice clone module 190, which generates the fluent synthetic speech 140, articulated in the voice of the instance of voice clone data 135 returned in response to the voice clone request 125. The fluent synthetic speech 140 is then transmitted to the audio-in port of the network signal/formatter module 245. However, the video signal 230 generated by the network signal comms module 210 is not used. Instead, the avatar generator module 405 generates an avatar video signal 420 that includes animated images of a speaking head of an individual. The output of the avatar generator module 405 connects to the video-in port of the network signal formatter/transmitter module 245.

More detail for operation of the FDT video conference server 490 is as follows. The FDT video conference server 490 creates an avatar name request message, or avatar name request 425, and includes the value of the keyword-value pair 104 from the user configuration data 260 as a parameter in the avatar name request 425. The value is an avatar descriptor. The server 490 then sends the avatar name request 425 to the avatar generator module 405.

The avatar generator module 405 receives the avatar name request 425 and passes the request 425 to the avatar data library 410. In response, the avatar data library 410 returns avatar data 426 in accordance with the avatar name request 425. The avatar generator module 405 also receives, as input, the fluent synthetic speech 140 generated by the voice clone module 190. The avatar generator module 405 then uses the fluent synthetic speech 140 and the avatar data 426 to create an animated avatar whose head, eye, and lip movements are consistent with the fluent synthetic speech 140.

The avatar data 426 can be constructed to represent the visage of the user or alternately can represent the visage of a cartoon character or another person, in examples. Realistic avatars that change facial expressions, head and lip movements that are synchronized with speech require extra processing time, which can delay the transmission of the avatar and the fluent representations of user speech to other conference session participants. For this reason, at least until video conference programs mature, simpler avatars are preferred.

In more detail, the avatar generator module 405 creates an avatar video signal 420 which includes the avatar. The avatar generator module 405 then sends the avatar video signal 420 to the video-in port of the network signal formatter/transmitter 245. The network signal formatter/transmitter 245 receives the fluent synthetic speech 140 at its audio-in port and receives the avatar video signal 420 at its video-in port, and combines the signals 140, 420 into a network-compatible signal 250. The network signal formatter/transmitter 245 transmits the network-compatible signal 250 over the network 60 to the other participants of the video conference session.

In summary, as with the FDT video conference server 390, the FDT video conference server 490 converts words spoken by a stuttering user 20 into fluent synthetic speech 140. The FDT video conference server 490 transmits the fluent synthetic speech 140 to participants in a video conference session, without transmitting the user's original audio signals 105/actual audible speech to the participants. In addition, if the text-to-speech module 110 of the voice clone module 190 is based on large language models, some or all of the residual disfluencies in the user's speech will be ‘erased’, i.e., many of the disfluent utterances will not survive transcription into the fluent synthetic speech 140. Thus, the FDT video conference server 490 facilitates fluent communication by an otherwise stuttering user during video conference sessions with other participants, and further represents the user 20 visually to other video conference session participants as an animated avatar.

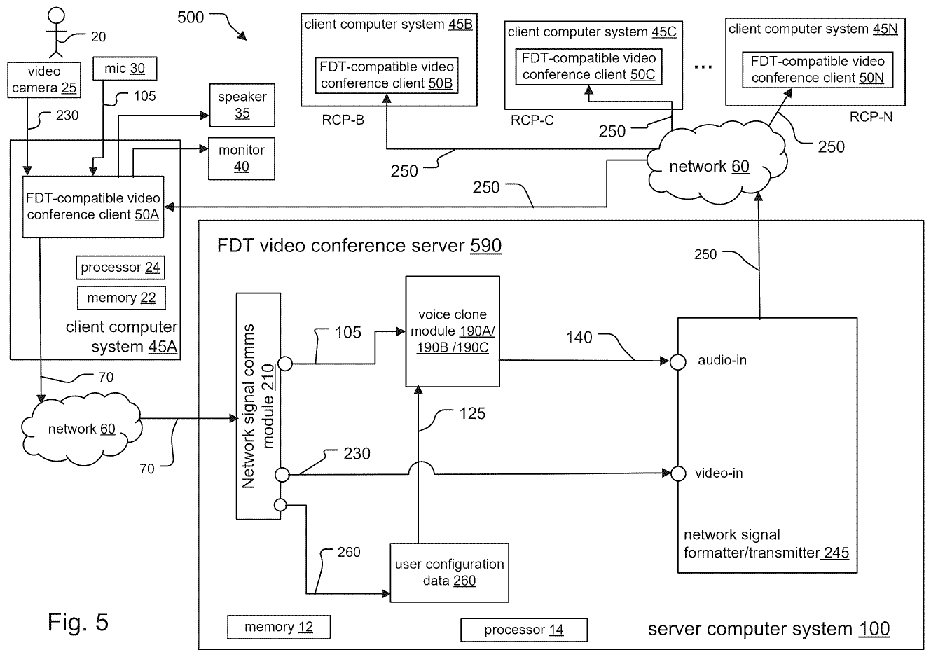

FIG. 5 is a schematic diagram of another video conference system 500. The video conference system 500 includes an FDT video conference server 590. The video conference system 500 has substantially similar components and is arranged in a substantially similar way as in the video conference system 300 of FIG. 3. However, there are differences. Like the FDT video conference server 390, the FDT video conference server 590 includes the network signal comms module 210, the user configuration data 260, the voice clone module 190 and the network signal formatter/transmitter 245, and clones user speech into fluent synthetic speech 140. Unlike the FDT video conference server 390, the FDT video conference server 590 represents the user visually by a video signal/the original video signal 230 captured by the video camera 25.

The FDT video conference server 590 is seemingly the most natural way to represent a stuttering user in a video conference session while ensuring that the stuttering user's audible speech cannot be heard by any of the conference call participants. This is because information content of the user's speech is transmitted to other call participants audibly via the fluent synthetic speech signal 140, and the user 20 is represented visually by their video images/video signals 230 captured by the video camera 25.

At the same time, the FDT video conference server 590 may be limited by the current processing speed of text-to-speech software modules. At present, text-to-speech modules cannot generate fluent synthetic cloned audio from a text stream in real time; rather, there is typically a latency or lag time of up to several seconds. Thus, the fluent synthetic speech 140 signal might be somewhat delayed relative to the user's video signal, and the audio and video signals in signal 250 might be somewhat out of synchronization as a result. This latency may impair the perceived quality of the stuttering user's presentations in video conference sessions.

Some stuttering users 20 may prefer the FDT video conference server 590, despite its possible latency issue, because the FDT video conference server 590 provides a full audible signal to video conference session participants along with real-time video of the stuttering user. At the same time, it is reasonable to expect that both the text-to-speech modules and CPU processing speed of the FDT video conference servers will improve in the future, possibly to the point that the latency becomes negligible. At that point, the FDT video conference server 590 will likely be the preferred embodiment of a server-based FDT video conference system.

The FDT video conference server 590 generally operates as follows. As in the FDT video conference servers 290, 390, and 490, the FDT video conference server 590 accepts a network-compatible signal 70 that contains the audio signal 105, video signal 230, and user configuration data 260. The incoming network-compatible signal 70 is received by the network signal comms module 210 which separates the signal 70 into an audio signal 105, video signal 230, and user configuration data 260 components. As in the FDT video conference servers 390 and 490, the FDT video conference server 590 creates a voice clone request 125 that includes the voice clone descriptor from the keyword-value pair 106 in the user configuration data 260, and sends the voice clone request 125 to the voice clone module 190. The voice clone module 190 then generates fluent synthetic speech 140 that contains the same words as in the audio signal 105, but articulated in the requested ‘voice’ of the voice clone data 135 obtained in response to the voice clone request 125.

The fluent synthetic speech 140 and the video signal 230 are transmitted to the audio-in and video-in ports, respectively, of the network signal formatter/transmitter 245. The network signal formatter/transmitter 245 combines the signals 140, 230 into a network-compatible signal 250 and then transmits the signal 250 to other video conference session participants via the network 60.

In summary, as in the FDT video conference servers 390 and 490, the FDT video conference server 590 converts words spoken by a stuttering user 20 into fluent synthetic speech 140. The FDT video conference server 590 transmits the fluent synthetic speech 140 to participants in a video conference session, without transmitting the user's actual audible speech to the participants. In addition, if the text-to-speech module 110 of the voice clone module 190 is based on large language models, some or all of the residual disfluencies in the user's speech will be ‘erased’, i.e., many of the disfluent utterances will not be transcribed and thus will not be included in the fluent synthetic speech 140. Thus, the FDT video conference server 590 facilitates fluent communication by an otherwise stuttering user during video conference sessions with other participants. The FDT video conference server 590 further represents the user visually to other participants as actual video images of the user 20.

Initial approaches to cloning user speech typically involved a two-step process: first, the speech was transcribed into text by a text-to-speech module, and then the transcription was converted back into an audio stream as fluent synthetic speech, in a cloned voiced, by a text-to-speech module. More recently, direct speech-to-speech (STS) modules have been developed which convert the input speech stream into an output speech stream without the intermediate step of converting the input speech into a transcription. See Tom Labiausse, Laurent Mazaré, Edouard Grave, Patrick Pérez, Alexandre Défossez, Neil Zeghidour, “High-Fidelity Simultaneous Speech-To-Speech Translation”, arXiv: 2502.03382, https://doi.org/10.48550/arXiv.2502.03382, submitted to Computation and Language on 5 Feb. 2025.

These STS modules may also translate the input speech into a different language. The language-translation feature is of secondary importance when used within a Fluent Digital Twin, but STS modules may offer the possibility of improved latency compared to conventional STT/TTS modules. There may be a tradeoff regarding latency versus transcription accuracy between the conventional STT/TTS modules and the direct speech-to-speech modules. However, this will likely change over time as the two technologies evolve.

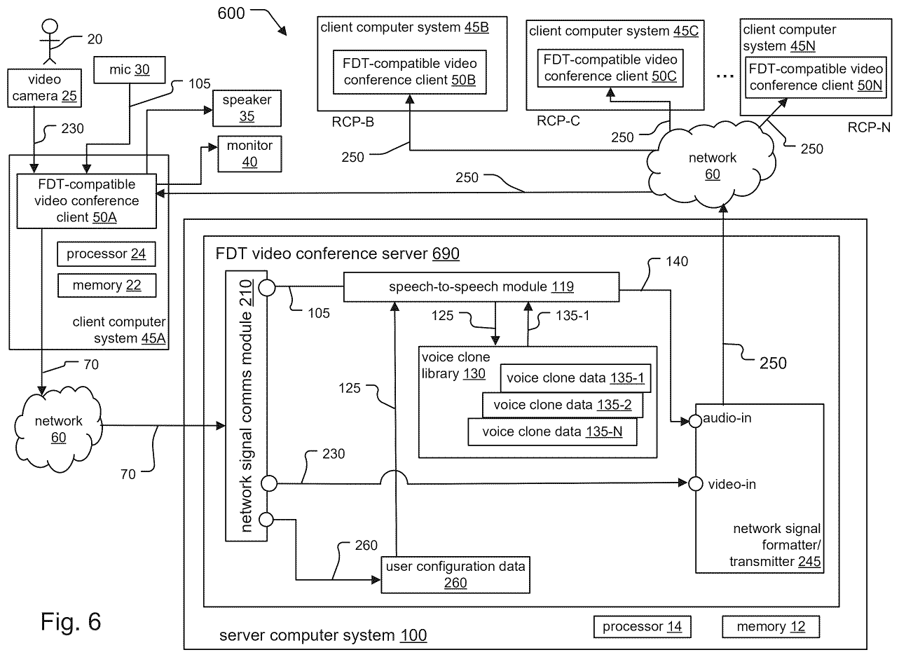

FIG. 6 shows yet another embodiment of a video conference system 600. The video conference system 600 includes an FDT video conference server 690. The video conference system 600 has substantially similar components and is arranged in a substantially similar way as in the video conference system 500 of FIG. 5. However, there are differences. Like the FDT video conference server 590, the FDT video conference server 690 includes the network signal comms module 210, the user configuration data 260, and the network signal formatter/transmitter 245; clones the original audio 105 of user speech into a fluent synthetic speech 140 signal; and represents the user visually by a video signal 230 captured by the video camera 25. However, the voice clone module 190 of the FDT video conference server 590, and the functionality that it provides, is replaced in the FDT video conference server 690 by a speech-to-speech module 119 and either a local copy of, or a reference to, a voice clone library 130.

The FDT video conference server 690 generally operates as follows. As in the FDT video conference server 590, the network signal comms module 210 separates the incoming network-compatible signal 70 into audio signal 105, video signal 230, and user configuration data 260 components. The FDT video conference server 690 creates a voice clone request 125 that includes the voice clone descriptor of the keyword-value pair 106 of the user configuration data 260, and sends the voice clone request 125 to the speech-to-speech module 119.

The speech-to-speech module 119 receives the audio signal 105 from the network signal comms module 210 and receives the voice clone request 125 as inputs. The speech-to-speech module 119 forwards the voice clone request 125 to the voice clone library 130, receives an instance of voice clone data 135-1 in response, and generates fluent synthetic speech 140 from the audio signal 105. The fluent synthetic speech 140 contains the same or very similar words as the audio signal 105, but is articulated in the specified ‘voice’ of the voice clone data 135-1 returned in response to the voice clone request 125.

The fluent synthetic speech 140 and the video signal 230 are transmitted to the audio-in and video-in ports, respectively, of the network signal formatter/transmitter 245. The network signal formatter/transmitter 245 combines the signals 140, 230 into a network-compatible signal 250 and then transmits the signal 250 over the network 60 to one or more participants in the video conference session.

The voice clone library 130 is shown as a component of the FDT video conference server 690 but can be implemented in different ways. In one example, the voice clone library 130 is located externally to the FDT video conference server 690, such as included in another computer system that is connected to the network 60. At startup of the video conference system 600 or the FDT video conference server 690, the FDT video conference server 690 might request a compressed version of the voice clone library 130 and unpack it to create a locally cached version, or merely requests updates to its local version.

It can also be appreciated that the FDT video conference server 690 can support different video representations of the user 20. The video signals 230 could alternatively be in the form of one or more static images 310 of the user 20, such as in the FDT video conference server 390 of FIG. 3, or an avatar video signal 420 as in the FDT video conference server 490 of FIG. 4.

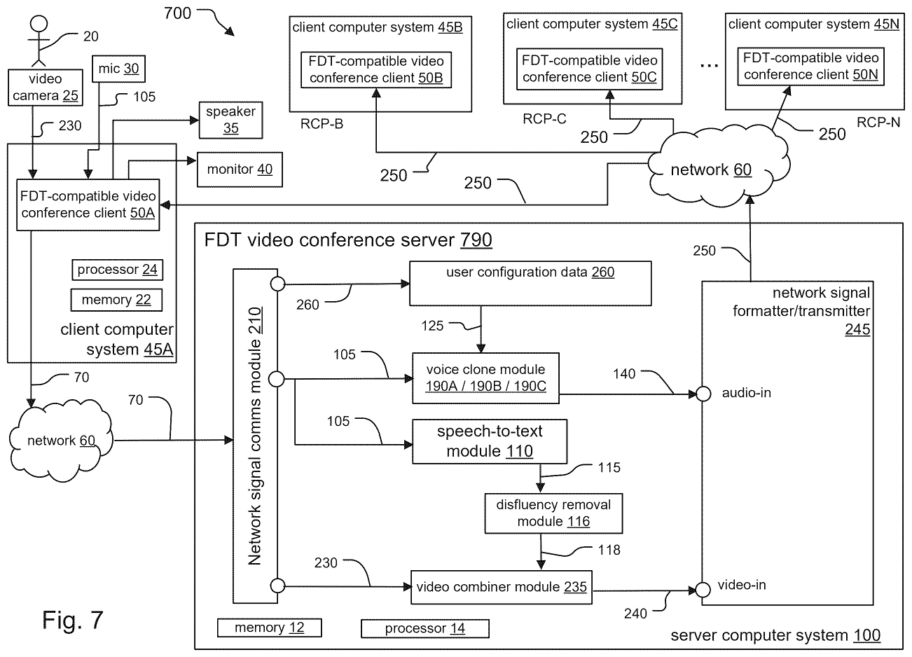

FIG. 7 is a schematic diagram of a video conference system 700 that includes an FDT video conference server 790. The FDT video conference server 790 clones user speech into fluent synthetic speech 140, and represents the user visually by a composite video signal 240. The composite video signal 240 includes the video signal 230 of the user captured by the video camera 25, with text signals representative of the user speech superimposed upon the video signal 230. Here, the superimposed text signals are the user's transcribed text 115, further transformed into fluent text 118.

The FDT video conference server 790 is arranged in a substantially similar manner as the FDT video conference server 290 of the video conference system 200 of FIG. 2. However, there are differences. As in the FDT video conference server 290, the FDT video conference server 790 includes a network signal comms module 210, user configuration data 260, a video combiner module 235 and a network signal formatter/transmitter module 245. Additionally, the FDT video conference server 790 includes a voice clone module 190 and a disfluency removal module 116.

The video conference system 700 generally operates as follows. At the FDT video conference server 790, the network comms module 210 separates the incoming network-compatible signal 70 into the audio signal 105, the video signal 230 and the user configuration data 260 components, and updates the local copy of the user configuration data 260.

The FDT video conference server 790 creates a voice clone request 125 that includes the voice clone descriptor of the keyword-value pair 106 of the user configuration data 260, and sends the voice clone request 125 to the voice clone module 190. The network comms module 210 also transmits the audio signal 105 to the voice clone module 190, and to the speech-to-text module 110. The voice clone module 190 then creates fluent synthetic speech 140 from the audio signal 105, articulated in the sounds of the voice clone data 135 returned in response to the voice clone request 125. The voice clone module 190 then transmits the fluent synthetic speech 140 to the audio-in port of the network signal formatter/transmitter 245.

The speech-to-text module 110 transcribes the input audio signals 105 into transcribed text 115 and transmits the transcribed text 115 to the disfluency removal module 116. The disfluency removal module 116 creates fluent text 118 from the transcribed text 115 and forwards the fluent text 118 to the video combiner module 235.

The video combiner module 235 receives the video signal 230 and the fluent text 118, and creates a composite video signal 240 that includes the video signal 230 and the fluent text 118 superimposed upon the video signal 230. The video combiner module 235 forwards the composite video signal 240 to the video-in port of the network signal formatter/transmitter 245. The network signal formatter/transmitter module 245 combines the received fluent synthetic speech 140 and the combined video signal 240 into a network-compatible signal 250, and transmits the network-compatible signal 250 over the network 60 to the video session participants.

In summary, as in the FDT video conference servers 390, 490, 590, and 690, the FDT video conference server 790 convert words spoken by a stuttering user 20 into fluent synthetic speech 140. The FDT video conference server 790 sends the fluent synthetic speech 140 to participants in a video conference session, without transmitting the user's original audio signals 105/actual audible speech, to the participants. The FDT video conference server 790 further represents the user visually by composite video signals 240. The advantage of displaying the transcribed text 115/fluent text 118 of the stuttering user 20 to all participants, including the stuttering user 20, is that the user 20 can confirm that his or her outgoing speech is relatively fluent. Thus, the FDT video conference server 790 facilitates fluent communication by an otherwise stuttering user 20 during video conference sessions.

In another implementation of the video conference system 700, the FDT video conference server 790 does not include the disfluency removal module 116. Here, the speech-to-text module 110 sends its output transcribed text 115 directly to the video combiner module 235, which superimposes the transcribed text 115 onto the video signal 230 to create the composite video signal 240.

It is important to note that none of the FDT video conference servers 290, 390, 490, 590, 690 and 790 forward the disfluent, original audio signals 105 of the stuttering user 20 to other conference participants. Rather, the FDT video conference servers create fluent representations of user speech based upon the user configuration data 260 and from at least the original audio signals 105, and forward the fluent representations of speech to the other participants of a video conference session.

It can also be appreciated that the aforementioned video conference systems which implement FDT capability in video conference servers, through the creation and use of transcribed text 115/fluent text 118, fluent synthetic speech 140 and composite video signals 240, in examples, can be additionally or alternatively implemented in a video conference client.

FIGS. 8 through 13 and FIG. 15 illustrate video conference systems that include different embodiments of FDT video conference clients. FIGS. 8, 9, 10, 11, 12 and 13 show video conference systems 800, 900, 1000, 1100, 1200 and 1300, respectively. The video conference systems 800, 900, 1000, 1100, 1200 and 1300, in turn, include FDT video conference clients 890, 990, 1090, 1190, 1290 and 1390, respectively. FIG. 15 shows a video conference system 1500 that includes an FDT-enabled web browser video conference client (FDT-enabled web browser) 1510.

The FDT video conference clients 890, 990, 1090, 1190, 1290 and 1390 each include user configuration data 260 as shown in FIG. 1F, and are configured by a stuttering user 20 to provide one or more fluent representations of user speech, based upon the configuration data 260, and from original audio signals 105 of the stuttering user 20. The descriptions of FIGS. 8-13 and 15 are included hereinbelow.

FIG. 8 is a schematic diagram of another video conference system 800. The video conference system 800 includes a client computer system 45 that communicates with a server computer system 100 over a network 60, and the client computer system 45 includes a FDT video conference client 890 that executes on/is hosted by the client computer system 45. The FDT video conference client 890 is a modified version of a standard video conference client that executes on the client computer system 45. The server computer system 100 includes a standard video conference server 150 that establishes video conference sessions that include the stuttering user 20 and other participants.

The FDT video conference client 890 includes similar components and provides similar functionality as the FDT video conference server 290 of FIG. 2, with regards to its ability to process fluent representations of audio and video, but is designed to operate on the client computer system 45 rather than on the server computer system 100. The server computer system 100 includes a video conference server 150 that establishes a video conference session between a stuttering user 20 of the FDT video conference client 890 and other participants. Unlike the FDT video conference servers previously described, the FDT video conference client 890 (and all other FDT video conference clients described hereinafter) do not include a network signal comms module 210. Rather, these FDT video conference clients, as their name suggests, are located on the client computer system 45 of the user 20 and can receive audio and video of the user 20 directly from the microphone 30 and video camera 25, respectively.

The client computer system 45 includes at least the FDT video conference client 890, a processor 24, a memory 22, a video camera 25 and a microphone (mic) 30. The FDT video conference client 890 includes a speech-to-text module 110, a disfluency removal module 116, a video combiner module 235, user configuration data 260, a client GUI 630 and a network signal formatter/transmitter 345. The user configuration data 260 is typically stored to the memory 22. The network signal formatter/transmitter 345 includes audio-in, video-in and data-in ports; however, the audio-in port is not used in this embodiment.

The FDT video conference client 890 generally operates as follows. The speech of the stuttering user 20 is transformed into audio signal 105/original audio signals by the microphone 30. Video images of the user 20 are transformed into video signal 230/original video signals by the video camera 25. The audio signal 105 is sent as input to the speech-to-text module 110, which generates transcribed text 115 of the words in the input audio signal 105. The transcribed text 115 is provided as input to the disfluency removal module 116, which generates fluent text 118 in response.

The video combiner module 235 receives the fluent text 118 from the disfluency removal module 116 and receives the video signal 230 from the video camera 25 as input, and creates a composite video signal 240 as output. The composite video signal 240 includes the video signal(s) 230 and the fluent text 118 superimposed onto the video signal(s) 230. The video combiner module 235 transmits the composite video signal 240 to the video-in port of the network signal formatter/transmitter module 345. The client GUI 630 connects to the data-in port of the module 345 and allows the user 20 to access and modify data in the user configuration data 260. Via the client GUI 630, the user 20 can configure various aspects of the video conference system 800 by updating/modifying the user configuration data 260.

The user configuration data 260 includes data that controls the user experience in the FDT video conference client 890 as well as data which controls how the video conference server 150 on the server computer system 100 defines the user experience. The user 20 configures the keyword-value pairs of the user configuration data 260 via the client GUI 630, and the client GUI 630 transmits the configuration data 260 to the data-in port of the network signal formatter/transmitter 345. The client GUI 630 also updates the local copy of the user configuration data 260.

The network signal formatter/transmitter 345 combines the user configuration data 260 with the composite video signal 240 to create a network-compatible signal 70 that the transmitter 345 sends over the network 60 to the video conference server 150. In the video conference system 800, no audio signal is provided to the network signal formatter/transmitter 345. As a result, there is no audio signal in the network-compatible signal 70; the user is effectively ‘muted’ during the video conference session.

In summary, the FDT video conference client 890 receives audio and video signals of a stuttering user, converts words spoken by the stuttering user 20 in the audio signals into text, and transmits the text to participants in a video conference session. Here, the video conference client 890 transmits the text by superimposing the transcribed text of the user speech on the user's video signals, and sends the combined signals to the participants, without transmitting the user's actual audible speech to the participants. If the speech-to-text module 110 is based on large language models, some or all of the residual disfluencies in the user's speech will be ‘erased’, i.e. many of the disfluent utterances will not be transcribed into the transcribed text 115. Thus, the FDT video conference client 890 facilitates fluent communication by an otherwise stuttering user 20 during video conference sessions.

In another implementation of the video conference system 800, the FDT video conference client 890 does not include the disfluency removal module 116. Here, the speech to-text module 110 sends its output transcribed text 115 directly to the video combiner module 235. The video combiner module 235 then superimposes the transcribed text 115 onto the video signal 230 to create the composite video signal 240.

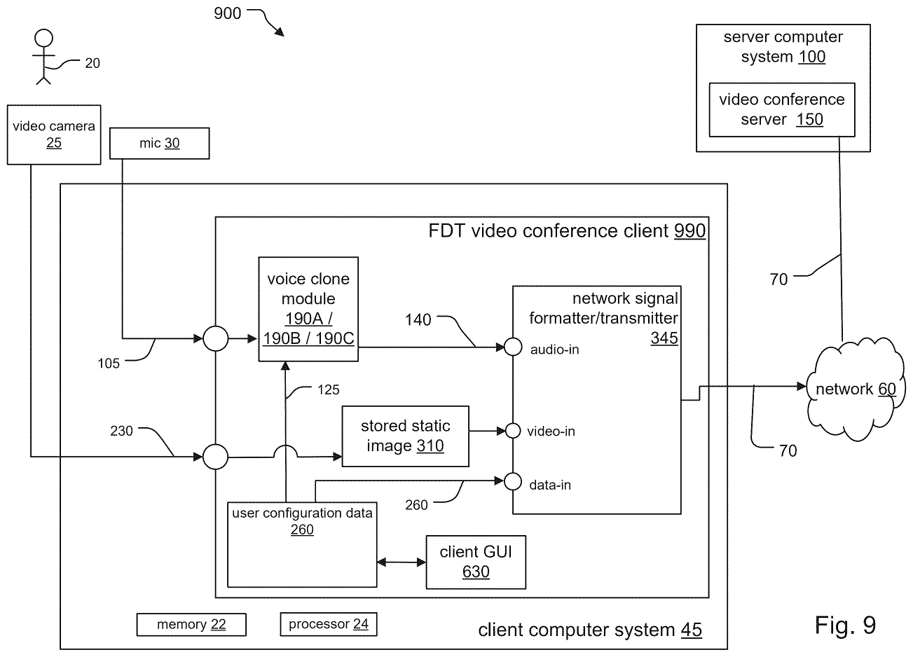

FIG. 9 is a schematic diagram of yet another video conference system 900. The system 900 is arranged in a similar fashion as the video conference system 800 of FIG. 8. The system 900 includes a client computer system 45 that communicates with other users on client computer systems (not shown), over a network 60 via a server computer system 100.

The client computer system 45 includes a FDT video conference client 990 that clones user speech into fluent synthetic speech 140, and the FDT video conference client 990 represents the user visually by a static image 310. The FDT video conference client 990 has similar components as the FDT video conference client 890 of FIG. 8, but there are differences. As in the FDT video conference client 890, the FDT video conference client 990 includes the user configuration data 260, the client GUI 630 and the network signal formatter/transmitter 345. However the FDT video conference client 990 replaces the speech-to-text module 110 and the optional disfluency removal module 116 of the FDT video conference client 890 with a voice clone module 190, and also includes a stored static image 310 of the user 20.

The FDT video conference client 990 operates in a similar fashion as the FDT video conference server 390 of FIG. 3 with regards to processing of user speech and video, with the main difference being that FDT video conference client 990 performs its computational processing at the client (specifically, at the client computer system 45), while the FDT video conference server 390 performs its computational processing at the server computer system 100.

The video conference system 900 is arranged and generally operates as follows. The speech of the user 20 is transformed into the audio signal 105 by the microphone 30. Video images of the user 20 are transformed into video signal 230 by the video camera 25. The client GUI 630 allows the user to view and modify data including the keyword-value pairs of the user configuration data 260.

The mic 30 converts the speech of the user 20 into the audio signal 105, which in turn is forwarded to the voice clone module 190. The FDT video conference client 890 creates a voice clone request 125, and includes the value of the keyword-value pair 106 from the user configuration data 260 as a parameter in the request 125. The value is a voice clone descriptor. The FDT video conference client 990 then sends the voice clone request 125 to the voice clone module 190. The voice clone module 190 receives the audio signal 105 as input, obtains voice clone data 135 associated with the voice clone descriptor from the voice clone library 130, and generates fluent synthetic speech 140 from the audio signal 105. The fluent synthetic speech 140 includes fluent versions of the same or very similar words as the audio signal 105, but is articulated in the specified ‘voice’ of the instance of voice clone data 135 obtained in response to the voice clone request 125.

The static image 310 of the user is stored in the memory 22, possibly extracted from the video signal 230. The static image 310 might also be provided by the user 20, included in the user configuration data 260 as the value for the keyword-value pair 112. The static image 310 is transmitted to the video-in port of the network signal formatter/transmitter module 345. The fluent synthetic speech 140 is transmitted to the audio-in terminal of module 345. The client GUI 630 transmits the user configuration data 260 to the data-in port of the network signal formatter/transmitter 345, which combines the user configuration data 260 with the fluent synthetic speech 140 and the static image 310 into a network-compatible signal 70. The network signal formatter/transmitter 345 transmits the network-compatible signal 70 over the network 60 to the video conference server 150.

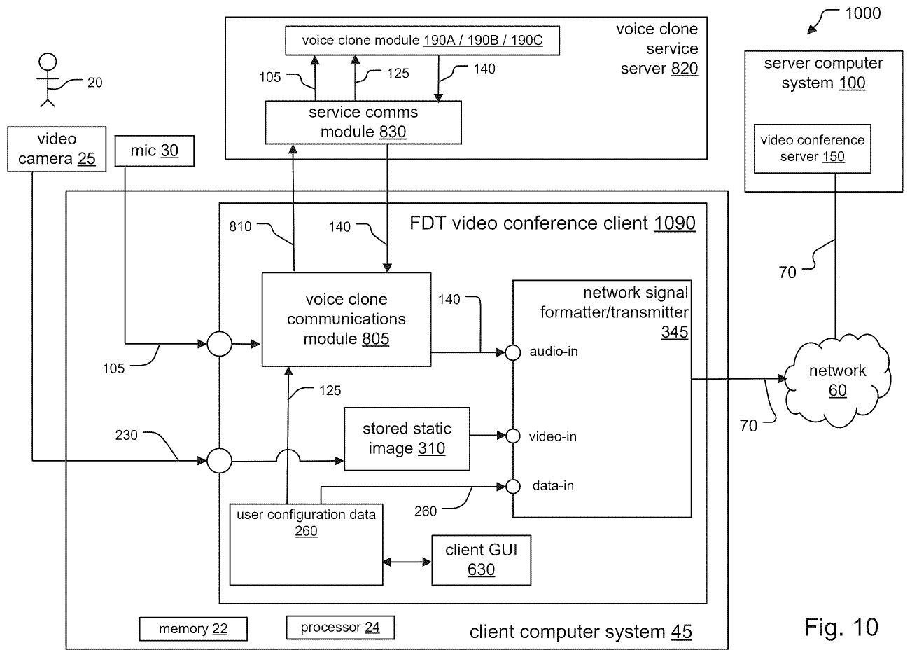

FIG. 10 is a schematic diagram of yet another video conference system 1000. The system 1000 includes an FDT video conference client 1090, and includes similar components as and is arranged in a similar fashion as the video conference system 900 of FIG. 9. However, the system 1000 additionally includes a voice clone service server 820 that includes a voice clone module 190 and a service communication (comms) module 830. The FDT video conference client 1090 also replaces the voice clone module 190 of the FDT video conference client 990 with a voice clone communications module 805 included in the FDT video conference client 1090.

The FDT video conference client 1090 clones user speech into fluent synthetic speech 140. The FDT video conference client 1090 represents the user visually by a static image 310, and uses the video clone service server 820 to generate the fluent synthetic speech 140. The main difference between the FDT video conference clients 990 and 1090 is that the FDT video conference client 990 includes the voice clone module 190 as an internal component, whereas the FDT video conference client 1090 is configured to communicate with an external voice clone module 190 that resides within the voice clone service server 820. The voice clone communications module 805 handles communications with the voice clone service server 820.

The video conference system 1000 generally operates as follows. The user's speech is transformed into audio signal 105 by the microphone 30. Video images of the user 20 are transformed into video signal 230 by the video camera 25. The audio signal 105 is transmitted to the voice clone communications module 805. The FDT video conference client 1090 creates a voice clone request 125 that includes the voice clone descriptor value from the keyword-value pair 106, and sends the voice clone request 125 to the voice clone communications module 805.

The voice clone communications module 805 combines the voice clone request 125 with the audio signal 105 to form a combined request signal 810, and transmits the combined request signal 810 to the service comms module 830 of the voice clone service server 820. The service comms module 830 extracts the audio signal 105 and the voice clone request 125 from the combined request signal 810 and transmits the audio signal 105 and the voice clone request 125 to the voice clone module 190.

The voice clone module 190 then generates fluent synthetic speech 140 from the audio signal 105, in the sounds of the voice clone data 135 obtained in response to the voice clone request 125. The voice clone module 190 sends the fluent synthetic speech 140 to the service comms module 830, which forwards the fluent synthetic speech 140 to the voice clone communications module 805. The voice clone communications module 805, in turn, transmits the fluent synthetic speech 140 to the audio-in port of the network signal formatter/transmitter module 345. The FDT video conference client 1090 also transmits the static image 310 and the user configuration data 260 to the video-in port and the data-in port, respectively, of the network signal formatter/transmitter 345.

The network signal formatter/transmitter 345 receives the fluent synthetic speech 140, the static image 310 and the user configuration data 260, combines these into a network-compatible signal 70, and transmits the network-compatible signal 70 over the network 60 to the video conference server 150. The video conference server 150 forwards the network-compatible signal 70 to the video conference session participants.

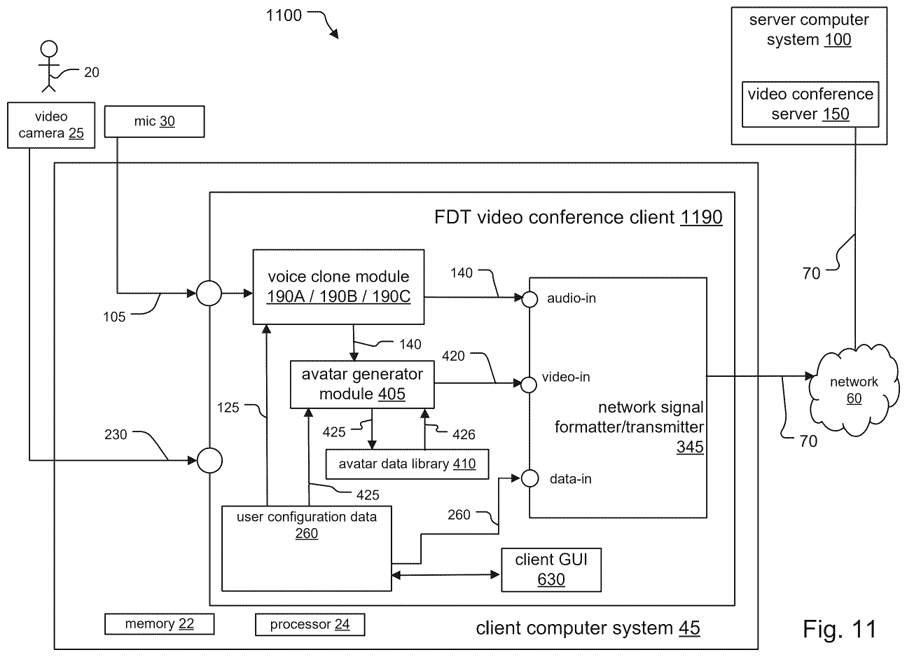

FIG. 11 is a schematic diagram of another video conference system 1100. The system 1100 is arranged in a similar fashion as the video conference system 900 of FIG. 9. The system 1100 includes a client computer system 45 that communicates with other users on client computer systems (not shown), over a network 60 via a server computer system 100.

The client computer system 45 includes an FDT video conference client 1190 that clones user speech into fluent synthetic speech 140, and which represents the user visually by an animated avatar/avatar video signal 420.

The FDT video conference client 1190 includes similar components and operates in a substantially similar fashion as the FDT video conference server 490 of FIG. 4 with regards to processing of user speech and video, with the main difference being that the FDT video conference client 1190 performs its computational processing at the client, (specifically, at the client computer system 45), while the FDT video conference server 490 performs its computational processing at the server computer system 100.

The video conference system 1100 generally operates as follows. The microphone 30 converts the audible speech of the user 20 into audio signal 105. The video camera 25 captures video images of the user 20 which the camera 25 transmits to the FDT video conference client 1190 as video signal 230. However, these video images are not transmitted to the network signal formatter/transmitter module 345.

The FDT video conference client 1190 creates a voice clone request 125 that includes the voice clone descriptor value from the keyword-value pair 106 of the user configuration data 260, and creates an avatar name request 425 that includes the avatar descriptor value included in the keyword-value pair 104 of the user configuration data 260. The FDT video conference client 1190 sends the voice clone request 125 to the voice clone module 190, and sends the avatar name request 425 to the avatar generator module 405.

The voice clone module 190 receives the audio signal 105 and the voice clone request 125, obtains the voice clone data 135 for the voice clone request 125 and reconstitutes the audio-input speech signal 105 into fluent synthetic speech 140. The fluent synthetic speech 140 is articulated in a voice of the voice clone data 135. The voice clone module 190 also transmits the fluent synthetic speech 140 to the avatar generator module 405.

The avatar generator module 405 receives the fluent synthetic speech 140 and the avatar name request 425. The avatar generator module 405 queries the avatar data library 410 using the avatar name request 425, and obtains avatar data 426 of a specific avatar, indicated by the avatar descriptor in the avatar name request 425.

The avatar generator module 405 uses the fluent synthetic speech 140 and the avatar data 426 to create an animated avatar video signal 420 whose head, eye, and lip movements may be consistent with the fluent synthetic speech 140, where the avatar video signal 420 appears to be speaking the fluent synthetic speech 140. The voice clone module 190 transmits the fluent synthetic speech 140 to the audio-in port of the network signal formatter/transmitter module 345, the avatar generator module 405 transmits the avatar video signal 420 to the video-in port of the network signal formatter/transmitter module 345, and the FDT video conference client 1190 transmits the user configuration data 260 to the data-in port of the network signal formatter/transmitter module 345.

The network signal formatter/transmitter module 345 combines the fluent synthetic speech 140, the avatar video signal 420, and user configuration data 260 into a network-compatible signal 70 and transmits the signal 70 over the network 60 to the video conference server 150.

In summary, the FDT video conference client 1190 conveys words spoken by a stuttering user, in the form of fluent synthetic speech 140, to participants in a video conference session, via the video conference server 150, without transmitting the user's original audio signals 105/actual audible speech to the other session participants. If the text-to-speech module 110 of the voice clone module 190 is based on large language models, some or all of the residual disfluencies in the user's speech will be ‘erased’, i.e., many of the disfluent utterances will not survive transcription into the transcribed text stream 115. Thus, the FDT video conference client 1190 facilitates fluent communication by an otherwise stuttering user 20 during video conference sessions. The FDT video conference client 1190 further represents the user 20 visually to other participants as an animated avatar.

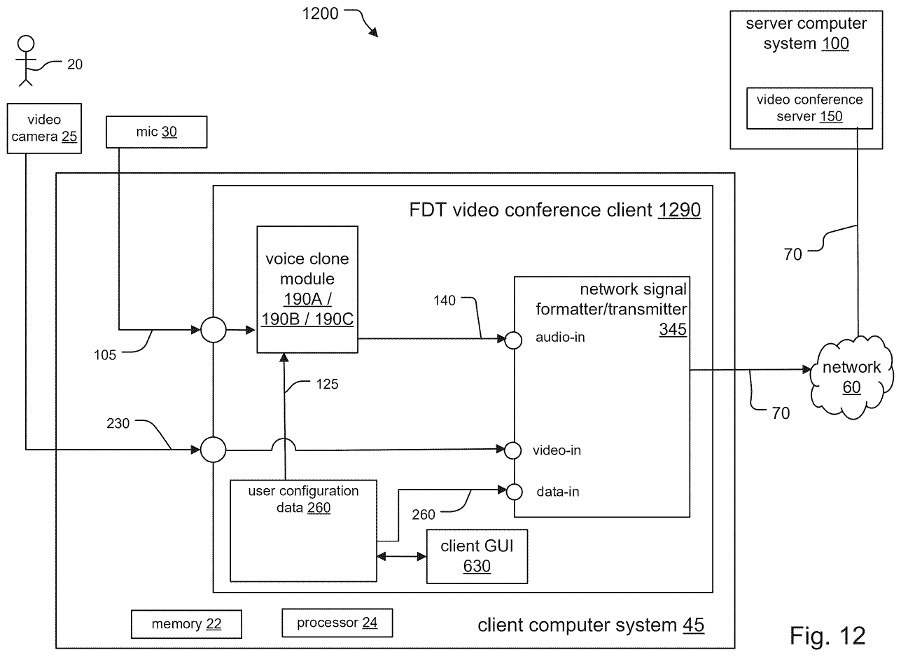

FIG. 12 is a schematic diagram of still another video conference system 1200. The system 1200 includes a client computer system 45 that communicates with other users on client computer systems (not shown), over a network 60 via a server computer system 100.

The client computer system 45 includes an FDT video conference client 1290 that transforms the user speech into fluent synthetic speech 140 and which represents the user visually by a video signal 230 captured by the video camera 25. As in the FDT video conference client 990, the FDT video conference client 1290 includes the user configuration data 260, the client GUI 630 and the voice clone module 190.

The FDT video conference client 1290 includes similar components and operates in a similar fashion as the FDT video conference server 590 of FIG. 5 with regards to processing of user speech and video, but the FDT video conference client 1290 performs its computational processing on the client (specifically, on the client computer system 45), whereas the FDT video conference server 590 performs its computational processing on the server computer system 100.

The video conference system 1200 generally operates as follows. The mic 30 converts the audible speech of user 20 into an audio signal 105. The video camera 25 captures video images of the user 20 which are transmitted to the FDT video conference client 1290 as a video signal 230.

The FDT video conference client 1290 creates a voice clone request 125, and sends the voice clone request 125 to the voice clone module 190. The voice clone request 125 includes the voice clone descriptor value in the keyword-value pair 106 of the user configuration data 260. The FDT video conference client 1290 also forwards the audio signal 105 received from the mic 30 to the voice clone module 190.

The voice clone module 190 obtains voice clone data 135 in response to the voice clone request 125, and creates fluent synthetic speech 140 from the audio signal(s), in the voice of the voice clone data 135.

The FDT video conference client 1290 transmits the fluent synthetic speech 140, the original video signal(s) 230 and the user configuration data 260 to the audio-in, video-in, and data-in ports, respectively, of the network signal formatter/transmitter module 345. The network signal formatter/transmitter module 345 combines the signals 140, 230 and the user configuration data 260 into the network-compatible signal 70. The FDT video conference client 1290 transmits the network-compatible signal 70 over the communications network 60 to the video conference server 150.

In summary, the FDT video conference client 1290 converts words spoken by a stuttering user 20 into fluent synthetic speech 140, and transmits the fluent synthetic speech 140 to other participants in a video conference session, via the video conference server 150, without transmitting the user's original audio signals 105/actual audible speech to the other participants. If the text-to-speech module 110 of the voice clone module 190 is based on large language models, some or all of the disfluencies in the user's speech will be ‘erased’, i.e., many of the disfluent utterances will not survive transcription into the transcribed text stream 115 generated within the voice clone module 190. Thus, the FDT video conference client 1290 facilitates fluent communication by an otherwise stuttering user 20 during video conference sessions. The FDT video conference client 1290 further represents the user visually to other video conference session participants using real-time video images 230 captured by a user video camera 25.

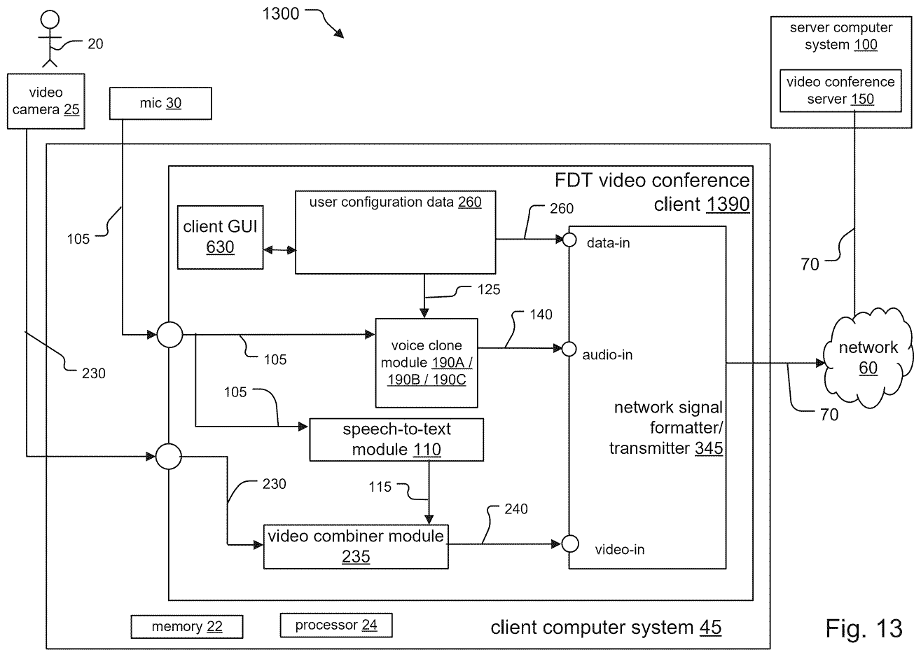

FIG. 13 illustrates still another video conference system 1300. The video conference system 1300 includes similar components as the video conference system 1200 of FIG. 12; however, there are differences. As compared to the FDT video conference client 1290 of FIG. 12, the FDT video conference client 1390 additionally includes a speech-to-text module 110 and a video combiner module 235. The FDT video conference client 1390 transforms the user speech into transcribed text 115 and fluent synthetic speech 140, represents the user visually by a video signal 230 captured by the video camera 25, and creates a composite video signal 240 that includes the video signal 230 with the transcribed text 115 superimposed onto the video signal 230.

Also, the FDT video conference client 1390 has similar components and operates in a substantially similar fashion as the FDT video conference server 790 of FIG. 7, with the main difference being that the FDT video conference client 1390 executes upon the client computer system 45. While the illustrated FDT video conference client 1390 does not include a disfluency removal module 116, an alternate implementation of the FDT video conference client 1390 may include the disfluency removal module 116.

The video conference system 1300 generally operates as follows. The mic 30 converts the speech of the stuttering user 20 into an audio signal 105, which is forwarded to the voice clone module 190 and to the speech-to-text module 110. The video camera 25 captures video signals 230 of the user 20, and the video signals 230 are forwarded to the video combiner module 235.

The FDT video conference client 1390 creates a voice clone request 125, and sends the voice clone request 125 to the voice clone module 190. The voice clone request 125 includes the voice clone descriptor value in the keyword-value pair 106 of the user configuration data 260. The voice clone module 190 obtains voice clone data 135 in response to the voice clone request 125, and creates fluent synthetic speech 140 from the audio signal(s), in the voice of the voice clone data 135.

The speech-to-text module 110 receives and transcribes the speech of the audio signal 105 into transcribed text 115. The speech-to-text module 110 transmits the transcribed text 115 to the video combiner module 235, which creates a composite video signal 240 that includes the original video signal 230 and the transcribed text 115 superimposed upon the video signal 230. The video combiner module 235 transmits the composite video signal 240 to the video-in port of the network signal formatter/transmitter module 345. The voice clone module 190 transmits the fluent synthetic speech 140 to the audio-in port of the network signal formatter/transmitter module 345, and the FDT video conference client 1390 sends the user configuration data 260 to the data-in port of the network signal formatter/transmitter module 345. The module 345 combines the audio signal 105, the video signal 240 and the user configuration data 260 into a network-compatible signal 70 and transmits the signal 70 over the network 60 to the video conference server 150.

In summary, the FDT video conference client 1390 converts words spoken by a stuttering user 20 into fluent synthetic speech 140, and transmits the fluent synthetic speech 140 to other participants in a video conference session, via the video conference server 150, without transmitting the user's original audio signals 105/actual audible speech to the other participants. The FDT video conference client 1390 further represents the user visually by composite video signals 240, which include the video images 230 onto which are superimposed the transcribed text 115 of the user's speech. Thus, the FDT video conference client 1390 facilitates fluent communication by an otherwise stuttering user 20 during video conference sessions in a client-based FDT system.

It is important to note that none of the FDT video conference clients 890, 990, 1090, 1190, 1290 and 1390 transmit the disfluent, original audio signals 105 of the stuttering user 20 to other conference participants, via the video conference server 150. Rather, the FDT video conference clients create fluent representations of user speech based upon the original audio signals 105, and transmit the fluent representations of speech to the other participants, via the video conference server 150.

FIG. 14 illustrates an exemplary screen 1400 of the client GUI 630 in the various embodiments of the FDT video conference client and the FDT-compatible video conference client 50. The screen 1400 includes a control screen 1402, a user window 1406 and a toolbar menu 1404. Also shown are buttons 1408.

The toolbar menu 1404 has various headings. These headings include Mute, Start Video, Security, Participants, FDT, Share Screen, Start Summary and More. Upon user selection of a heading in the toolbar menu 1404, the screen 1400 typically presents a different content-specific control screen 1402. The user can then adjust settings associated with the selected heading in the control screen 1402. In the illustrated example, the FDT heading is selected, and user-selectable content associated with the FDT heading is displayed in the control screen 1402. Depending upon the user selections in the control screen 1402, different content might be presented in the user window 1406.

The control screen 1402 includes different selectable headings. These headings include: Fluent Digital Twin (FDT), Select video output to callers, Select audio output to callers, Select cloned voice, and Select avatar headings. Note that the control screen 1402 illustrated in FIG. 14 pertains to an implementation where the video conference client or server allows the user to choose from one of several possible implementations of the FDT functionality; if instead only one FDT implementation is offered, then the control screen 1402 would be greatly simplified.

In the illustrated example, the Fluent Digital Twin heading provides a mechanism for the user to turn on and off the FDT functionality; value “on” is selected. In response to the user selection, the client GUI 630 updates the keyword-value pair 102 in the user configuration data 260. The Select video output to callers heading allows the user 20 to select what type of video signals will be transmitted to callers/other participants of the video conference session; value “avatar” is selected. In response to the user selection, the client GUI 630 updates the keyword-value pair 110 in the user configuration data 260.

The Select audio output to callers heading allows the user 20 to select what type of audio signals will be transmitted to callers on the video conference session; value “cloned speech” is selected. In response to the user selection, the client GUI 630 updates the keyword-value pair 108 in the user configuration data 260. The Select cloned voice heading enables the user 20 to select a ‘voice’ for the cloned synthetic speech; value “Walter Cronkite” is selected, and the client GUI 630 saves a voice clone descriptor for the selected voice to the keyword-value pair 106 of the user configuration data 260. The Select avatar heading allows the user 20 to select an avatar to represent the user; value “Tom Brady” is selected, and the client GUI 630 saves an avatar descriptor for the selected avatar to the keyword-value pair 104 of the user configuration data 260. In this example, because the user 20 has just selected the use of an avatar for video output and the “Tom_Brady” avatar, but that avatar has not yet been activated, the displayed image of the user 20 in the user window 1406 is that of the user 20, not Mr. Brady.

Additionally, the control screen 1402 includes the ability to select a static image 310 for the user 20. This image can be selected from images on the user's client computer system 45. For this purpose, in one example, the user 20 can select the user window 1406, and in response to the selection, a file browser widget of the user's client computer system 45 allows the user to select an image. In response to the selection, the client GUI 630 displays the image in the user window 1406, and the client GUI 630 saves a descriptor for the static image 310 to the keyword-value pair 112 of the user configuration data 260.

The buttons 1408 include “sign in”, “view” and “end”. These buttons, when selected, respectively allow the user 20 to: begin an authenticated video conference session with the FDT video conference servers 290, 390, 490, 590, 690 and 790 or the video conference server 150 of FIGS. 8 through 13; view information currently selected in the control screen 1402 and/or the toolbar menu 1404; and end an existing session, respectively. It can be appreciated that the screen 1400 can be employed, irrespective of whether the actual FDT functionality is implemented on the FDT video conference client or on the FDT video conference server.

The client GUI 630 typically updates the user configuration data 620 in response to each user change within the client GUI 630. Alternatively, the client GUI 630 might include a commit facility (such as “Perform Changes” button, not shown) that allows the user 20 to stage multiple changes, and then enact all the changes at once in response to selection of the commit facility/“Perform Changes” button.

FIG. 15 is a schematic diagram of another video conference system 1500. The system 1500 includes a server computer system 100 and a client computer system 45. The server computer system 100 includes a video conference server 150. The client computer system 45 communicates with the server computer system 100 and with other users on client computer systems (not shown), over a network 60.

The client computer system 45 includes an FDT-enabled web browser 1510, receives original audio signals 105 of a stuttering user 20 from a microphone 30, and receives original video signals 230 of the user from a video camera 25. The FDT-enabled web browser 1510 converts or otherwise transforms the original user speech 105 into fluent text 118 and fluent synthetic speech 140, and creates a composite video signal 240. The composite video signal 240 includes the original video signals 230, upon which the fluent text 118 is superimposed.

The FDT-enabled web browser 1510 includes a FDT audio-video generator module 1520 and a standard, unmodified video conference client 47. The video conference client 47 might instead be a separate program from the FDT-enabled web browser 1510 on the same client computer system 45 and is programmatically linked to the FDT-enabled web browser 1510. The video conference client 47 includes a site-requested webcam port, also known as a video-in port, and a site-requested mic port, also known as an audio-in port. The FDT audio-video generator module 1520 includes a speech-to-text module 110, a disfluency removal module 116, a text-to-speech module 120 and a video combiner module 235.

The FDT-enabled web browser 1510 differs qualitatively from the FDT video conference clients in FIGS. 8-13 in that it is not a modified version of an existing video conference client 47. Instead, the FDT-enabled web browser 1510 is a custom web browser that enables users to access World Wide Web compliant web page content over the Internet.

The browser 1510 is configured to send the fluent synthetic speech 140, as a spoofed audio signal, to the audio-in port of the video conference client 47. The browser 1510 is also configured to send the composite video signal 240, as a spoofed video signal, to the video-in port of the video conference client 47. The use of the custom browser 1510 avoids the security measures imposed by commercial web browsers which preclude, or at least complicate, the transmission of the fluent synthetic speech 140 as a spoofed audio signal to the audio-in port, and the transmission of the composite video signal 240 as a spoofed video signal to the video-in port of the video conference client 50. In addition, the use of a custom web browser precludes the need to manually configure the audio-in and video-in ports of the video conference client 47 to accept these spoofed signals 140 and 240, respectively.

The video conference system 1500 has an advantage over the previously disclosed video conference systems, namely, that the system 1500 does not require any changes to either the video conference client 47 or the video conference server 150 of existing video conference programs 202. As a result, an FDT-enabled video conference service based on the browser 1510 can be ‘rolled out’ commercially without having to obtain the approval of existing video conference programs 202 and services.

The video conference system 1500 generally operates as follows. The microphone 30 converts the original audible speech of the stuttering user 20 into original audio signals 105. The video camera 25 captures video images of the user 20 which are converted into original video signals 230. The audio signals 105 and the video signals 230 are transmitted to the FDT audio-video generator module 1520, which is represented as a dashed line in FIG. 15. Inside module 1520, the original audio signals 105 are received by the speech-to-text module 110, which transcribes the original audible speech signals into transcribed text 115. If module 110 is based on artificial language Large Language Models (LLMs), at least some of the disfluencies that may be present in the original audio signals 105 will not be propagated into the transcribed text 115, that is, the transcription text 115 may be more ‘fluent’ than the original speech. The transcribed text 115 is then transmitted as input to the disfluency removal module 116, which removes most or all of the residual disfluencies, and generates fluent text 118 as output.

The fluent text 118 is transmitted to, and processed by, the text-to-speech module 120. The module 120 generates fluent synthetic speech 140 that is transmitted to the audio-in port of the video conference client 50. The audio-in port is also labeled as a ‘site-requested mic’ port because the browser 1510 instructs the video conference client 50 to use the fluent synthetic speech 140 in place of the standard mic 30 as the source of audio information.

Note that for clarity of presentation, FIG. 15 does not show the user configuration data 260 which contains, among other specifications, which of several instances of voice clone data 135 are to be used by the text-to-speech module 120 when it generates the fluent synthetic speech 140.

In parallel, inside the FDT audio-video generator module 1520, the original video signals 230 and the fluent text 118 are transmitted to the video combiner module 235, which superimposes the fluent text 118 onto the original video signals 230, thereby creating the composite video signal 240 which is transmitted to the video-in port of the video conference client 47.

The video conference client 47 processes the received fluent synthetic speech 140 and the composite video signal 240 to create the network-compatible signal 70, and transmits the signal 70 over the network 60 to the video conference server 150.

It is important to note that in FIG. 15, the modules 110, 116, 120, and 235 are configured to implement a specific method for removing disfluencies from the original audio signals 105, namely, the same method that is used by the FDT video conference server 790 and the FDT video conference client 1390. By suitable replacement of modules within the browser 1510 and/or its FDT audio-video generator module 1520, the functionality of all of the embodiments of the FDT video conference servers in FIGS. 2 through 7 and the FDT video conference clients in FIGS. 8 through 13 could be implemented/realized.

In this way, the video conference system 1500 includes a client computer system 45 including a processor 24 and a memory 22, and an FDT-enabled web browser 1510 loaded into the memory 22 and executed by the processor 24. The FDT-enabled web browser 1510 includes, or is otherwise in communication with, a video conference client 47.

The FDT-enabled web browser 1510 is configured to: 1) receive original user speech of a stuttering user 20, in the form of original audio signals 105 obtained by and sent from a microphone 30 at the video conference client 47, where the user 20 is a participant in a video conference session established by a video conference server 150 in communication with the video conference client 47; 2) receive original video of the stuttering user, in the form of original video signals 230, obtained by and sent from a video camera 25 at the video conference client 47; 3) create one or more fluent representations of speech of the user from the original audio signals 105; 4) create replacement video signals that are either based on the original video signals 230, or that are not based upon the original video signals 230; and 5) transmit the one or more fluent representations of speech, along with the original video signals 230 or the replacement video signals, to the video conference client 47. The video conference client 47 then forwards the one or more fluent representations of speech, along with the original video signals or the replacement video signals, over a network 60 to the video conference server 150. The video conference server 150, in turn, forwards the one or more fluent representations of speech, along with the original video signals 230 or the replacement video signals, to other participants of the video conference session.

In summary, the FDT-enabled web browser 1510 converts words spoken by a stuttering user into fluent synthetic speech 140, and forwards the fluent synthetic speech 140 to participants in a video conference session, without transmitting the user's actual/original audio signals 105 to the other session participants.

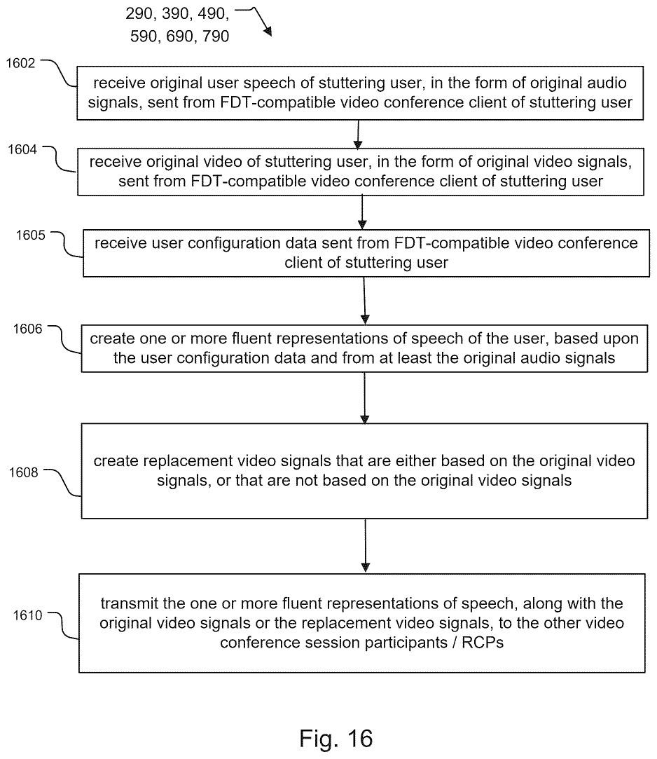

FIG. 16 discloses a method of operation of an FDT video conference server, such as the embodiments of the FDT video conference servers 290, 390, 490, 590, 690 and 790 of FIGS. 2, 3, 4, 5, 6 and 7, respectively, described hereinabove. The method begins at step 1602.

At step 1602, the FDT video conference server receives original user speech of the stuttering user 20, in the form of original audio signals 105 of the user 20, sent from the FDT-compatible video conference client 50 of the stuttering user 20. The FDT video conference server is included in/is hosted by the server computer system 100, while the FDT-compatible video conference client 50 is included in/is hosted by the client computer system 45. The original audio signals 105 were obtained by the microphone 30 at the client computer system 45.

In step 1604, the FDT video conference server receives original video of the stuttering user 20, in the form of original video signals 230, sent from the FDT-compatible video conference client 50 of the stuttering user 20. Here, the original audio signals 105 were obtained by the video camera 25 at the client computer system 45. Then, in step 1605, the FDT video conference server receives user configuration data 260 sent from the FDT-compatible video conference client 50 of the stuttering user 20.

In steps 1602 through 1605, the FDT video conference server receives the original audio signals 105, the original video signals 230, and the user configuration data 260 by extracting each from the network-compatible signal 70 sent from the FDT-compatible video conference client 50.

According to step 1606, the FDT video conference server creates one or more fluent representations of user speech of the user 20, based upon the user configuration data 260 and from at least the original audio signals 105. The fluent representations of user speech can be any of the text-based or audio-based fluent representations of user speech previously disclosed. In step 1608, the FDT video conference server creates replacement video signals that are either based upon the original video signals 230, or that are not based upon the original video signals 230.

With reference to the embodiments of the FDT video conference server previously disclosed, and with reference to Table 1 hereinabove, the replacement video signals based upon the original video signals 230 can include the stored static image(s) 310 of the user 20, disclosed in the FDT video conference server 390. The stored static image(s) 310 are typically extracted from the original video signals 230, but could also be provided by the user 20 via the FDT-compatible video conference client, which then sends the static image 310 to the FDT video conference server 390. As to the replacement video signals that are not based on the original video signals 230, these replacement video signals can include the avatar video signal 420 of the FDT video conference server 490, in one example.

In step 1610, the FDT video conference server then transmits the one or more fluent representations of speech, along with either the original video signals 230 or the replacement video signals, to the other video conference session participants/RCPs. See at least Table 1, hereinabove, for the different combinations of fluent representations of user speech, and video representations of the user 20, created and provided by the different FDT video conference server embodiments disclosed herein.

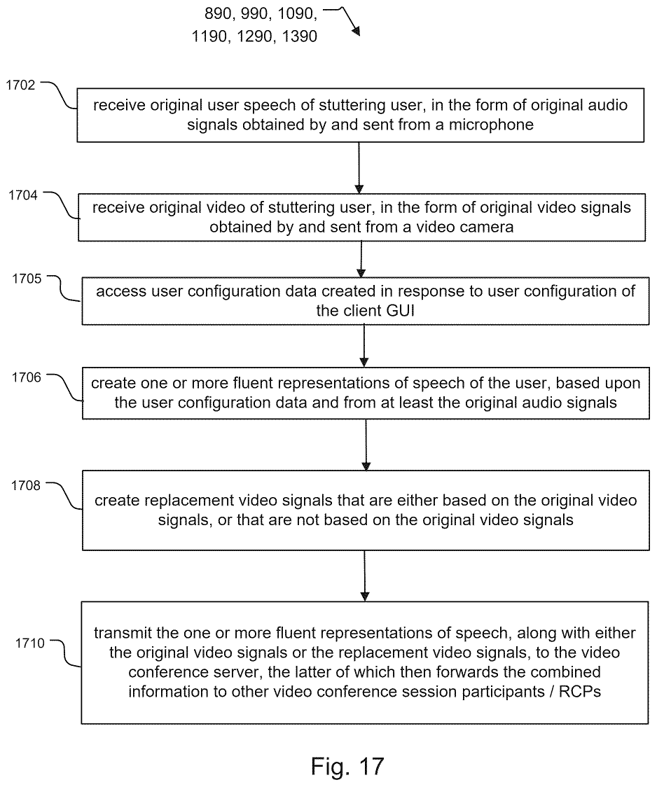

FIG. 17 discloses a method of operation of an FDT video conference client, such as the embodiments of the FDT video conference clients 890, 990, 1090, 1190, 1290 and 1390 described hereinabove. The method begins at step 1702.

At step 1702, the FDT video conference client receives original user speech of the stuttering user 20, in the form of original audio signals 105 of the user 20, obtained by and sent from the microphone 30 at the client computer system 45.

In step 1704, the FDT video conference client receives original video 230 of the stuttering user 20, in the form of original video signals 230, obtained by the video camera 25 at the client computer system 45. Then, in step 1705, the FDT video conference client either accesses the user configuration data 260, or receives modified user configuration data 260 in response to user configuration of the client GUI 630.

According to step 1706, the FDT video conference client creates the one or more fluent representations of user speech of the user 20, based upon the user configuration data 260 and from at least the original audio signals 105. The fluent representations of user speech can be any of the text-based or audio-based fluent representations of user speech previously disclosed. In step 1708, the FDT video conference client creates replacement video signals that are either based upon the original video signals 230, or that are not based upon the original video signals 230.

With reference to the embodiments of the FDT video conference client previously disclosed, and with reference to Table 1 hereinabove, the replacement video signals based upon the original video signals 230 can include the stored static image(s) 310 of the user 20, disclosed in the FDT video conference clients 990 and 1090. The replacement video signals that are not based upon the original video signals 230 can include the avatar video signal 420 of the FDT video conference client 1190.

In step 1710, the FDT video conference client then transmits the one or more fluent representations of speech, along with either the original video signals 230 or the replacement video signals, to the video conference server 150. The video conference server 150, in turn, forwards this combined information to the other video conference session participants/RCPs. See at least Table 1, hereinabove, for the different combinations of fluent representations of user speech, and video representations of the user 20, created and provided by the different FDT video conference client embodiments disclosed herein.

It will be appreciated that existing video conference programs may already support mechanisms for users to store and update their static image as part of their user “profile”, which is generically part of their user configuration data 260. For example, Zoom allows a user to upload a static image to visually represent the user to the video conference server, and the static image is displayed to the Zoom session participants if a user disables their webcam.

Various video conference programs may elect to implement support for static image management in a variety of ways. In one example, the static image can be permanently stored in the video conference client and uploaded as needed, or it can be stored in the video conference server. If the static image is stored at the video conference server, it can be updated through the use of the video conference client or through a separate means, such as a web portal that manages user profile information.

In the video conference systems 300, 900 and 1000 disclosed herein, the user's static image can represent the user visually to the video conference session participants. The mechanism by which this static image is identified and stored is an implementation detail, is of secondary importance to the underlying functionality, and may differ in different video conference systems.

While the aforementioned embodiments of the FDT video conference client and the FDT video conference server show arrangements of discrete software components or modules, it can be appreciated that one or more of these components or modules could be combined. In one example, with reference to the FDT video conference server 490 and the FDT video conference client 1190, the voice clone module 190 and the avatar generator module 405 might instead be implemented as a unitary module that creates both fluent synthetic speech 140 and avatar video signals 420. In more detail, the unitary module might accept the following as inputs: the original audio 105 of the stuttering user, and a voice clone descriptor that identifies the voice of a selected individual, included in user configuration data 260 provided by the stuttering user 20. In response to these inputs, the unitary module can generate fluent synthetic speech 140 in the voice of the selected individual.

In a similar vein, the unitary module might also accept an avatar descriptor that identifies an avatar of a selected individual as input, included in the user configuration data 260 provided by the stuttering user 20. In response to this input, the unitary module can generate an avatar video signal 420 that replaces the original video 230 of the user 20, obtained by the user's video camera 25. Here, lip and/or facial movements of the avatar in the avatar video signal 420 can be informed by the fluent synthetic speech 140.

In another example, with reference to the FDT video conference server 790 and the FDT video conference client 1390, the voice clone module 190, speech-to-text module 110, and the video combiner module 235 might instead be implemented as a unitary module. This unitary module could create fluent synthetic speech 140 of a voice clone selected by the user 20, modify video 230 of the stuttering user 20 to include a text-based fluent representation of speech of the stuttering user 20 superimposed upon the video 230, thus creating the composite video signal 240. Here, the unitary module can have the following inputs: the original audio 105 of the stuttering user, a voice clone descriptor that identifies the voice of a selected individual, and a video signal 230 of the stuttering user 20. In response to the inputs, the unitary module can create the fluent synthetic speech 140 and the composite video signal 240.

What is claimed is:

1. A video conference system, the system comprising:
a server computer system including a processor, a memory, and a fluent digital twin video conference server application, also known as an FDT video conference server, loaded into the memory and executed by the processor;
a first client computer system including a FDT-compatible video conference client that is loaded into a memory of and is executed by a processor of the first client computer system, wherein the FDT-compatible video conference client includes a client GUI and user configuration data, and wherein the stuttering participant accesses the client GUI to modify the user configuration data, and wherein the FDT-compatible video conference client is configured to receive original audio and original video of the stuttering participant;
wherein the FDT video conference server is configured to:
establish a video conference session that includes the stuttering participant and one or more other participants;
receive the user configuration data, the original audio and the original video of the stuttering participant over the video conference session, sent from the FDT-compatible video conference client;
create one or more fluent representations of speech of the stuttering participant based upon the user configuration data and from at least the original audio; and
transmit the one or more fluent representations of speech of the stuttering participant over the video conference session to the one or more other participants.

2. The video conference system of claim 1, wherein the FDT video conference server includes:
a speech-to-text module that is configured to transcribe the original audio of the stuttering participant into fluent transcribed text; and
a video combiner module that is configured to superimpose the fluent transcribed text upon the original video of the stuttering participant to create a composite video signal;
wherein the one or more fluent representations of speech of the stuttering participant include the fluent transcribed text of the composite video signal.

3. The video conference system of claim 1, further comprising:
a speech-to-text module included in the FDT video conference server that transcribes the original audio of the stuttering participant into fluent transcribed text; and
a voice clone module that is configured to:
receive the fluent transcribed text and a voice clone request message as inputs, the voice clone request message including a voice clone descriptor of a selected individual, and wherein the voice clone descriptor is obtained from and also included within the user configuration data;
obtain voice clone data for the voice clone descriptor in the voice clone request message; and
generate an audio representation of the fluent transcribed text in a voice of the selected individual associated with the voice clone data in response, wherein the audio representation of the fluent transcribed text in the voice of the selected individual is also known as fluent synthetic speech;
wherein the one or more fluent representations of speech of the stuttering participant include the fluent synthetic speech.

4. The video conference system of claim 3, wherein the voice clone module is included within another computer system that is different from and in communication with the server computer system.

5. The video conference system of claim 3, wherein the voice clone module is included within the FDT video conference server.

6. The video conference system of claim 3, wherein the user configuration data includes a descriptor associated with a static image of the user, and wherein the FDT video conference server is configured to obtain the static image from the memory using the descriptor, and to transmit the static image along with the fluent synthetic speech to the one or more other participants.

7. The video conference system of claim 3, wherein the FDT video conference server is configured to receive the original video of the stuttering participant from the FDT-compatible video conference client, and to transmit the original video along with the fluent synthetic speech to the one or more other participants.

8. The video conference system of claim 3, further comprising:
an avatar generator module that is configured to:
receive an avatar name request message that includes an avatar descriptor of a selected avatar, wherein the avatar descriptor is obtained from and also included in the user configuration data;
obtain avatar data for the avatar descriptor in the avatar name request message; and
replace the original video of the stuttering participant with an avatar video signal that includes the avatar data, wherein the avatar data includes at least lip movements that are consistent with the fluent synthetic speech;
wherein the FDT video conference server is configured to transmit the avatar video signal along with the fluent synthetic speech to the one or more other participants.

9. The video conference system of claim 1, further comprising:
a speech-to-speech module included in the FDT video conference server that is configured to:
receive the original audio of the stuttering participant, and a voice clone name request message that includes a voice clone descriptor of a selected voice clone, wherein the voice clone descriptor is obtained from and also included within the user configuration data;
perform a lookup of the voice clone descriptor at a voice clone library, to obtain voice clone data of the selected individual associated with the voice clone descriptor; and
create a fluent audio signal from the original audio, presented in a cloned voice, wherein the cloned voice is based upon the voice clone data of the selected individual;
wherein the one or more fluent representations of speech of the stuttering participant include the fluent audio signal presented in the cloned voice.

10. The video conference system of claim 1, wherein the FDT video conference server does not transmit the original audio of the stuttering participant to the one or more other participants.

11. A video conference system, the system comprising:
a server computer system including a video conference server application, also known as a video conference server, configured to establish video conference sessions that include audio and video of participants;
a first client computer system including a processor, a memory and a fluent digital twin video conference client application, also known as an FDT video conference client, loaded into the memory and executed by the processor, wherein a stuttering individual participant configures the FDT video conference client to receive original audio and original video of the stuttering participant, and wherein the FDT video conference client includes a client GUI and user configuration data, and wherein the stuttering participant accesses the client GUI to modify the user configuration data;
wherein the FDT video conference client is configured to create one or more fluent representations of speech of the stuttering participant based upon the user configuration data and from at least the original audio; and
wherein upon the video conference server establishing a video conference session that includes the stuttering participant and one or more other participants, the FDT video conference client is configured to transmit the one or more fluent representations of speech of the stuttering participant over the video conference session to the video conference server, and the video conference server transmits the one or more fluent representations of speech of the stuttering participant over the video conference session to the one or more other participants.

12. The video conference system of claim 11, wherein the FDT video conference client includes:
a speech-to-text module that is configured to transcribe the original audio of the stuttering participant into fluent transcribed text; and
a video combiner module that is configured to superimpose the fluent transcribed text upon the original video of the stuttering participant to create a composite video signal;
wherein the one or more fluent representations of speech of the stuttering participant include the fluent transcribed text of the composite video signal.

13. The video conference system of claim 11, further comprising:
a speech-to-text module included in the FDT video conference client that is configured to transcribe the original audio of the stuttering participant into fluent transcribed text; and
a voice clone module that is configured to:
receive the fluent transcribed text and a voice clone request message as inputs, the voice clone request message including a voice clone descriptor of a selected individual, and wherein the voice clone descriptor is obtained from and also included within the user configuration data;
obtain voice clone data for the voice clone descriptor in the voice clone request message; and
generate an audio representation of the fluent transcribed text that is presented in a voice of the selected individual associated with the voice clone data in response, wherein the audio representation of the fluent transcribed text presented in the voice of the selected individual is also known as fluent synthetic speech;
wherein the one or more fluent representations of speech of the stuttering participant include the fluent synthetic speech.

14. The video conference system of claim 13, wherein the voice clone module is included within another computer system that is different from and in communication with the client computer system.

15. The video conference system of claim 13, wherein the voice clone module is included within the FDT video conference client.

16. The video conference system of claim 13, wherein the user configuration data includes a descriptor associated with a static image of the user, and wherein the FDT video conference client is configured to obtain the static image from the memory using the descriptor, access a static image selected by the stuttering participant from the memory, and to send the static image as the video of the stuttering participant to the video conference server, and wherein the video conference server transmits the static image along with the fluent synthetic speech to the one or more other participants.

17. The video conference system of claim 13, wherein the FDT video conference client is configured to receive the original video of the stuttering participant from a video camera connected to the first client computer system, and to send the original video of the stuttering participant along with the fluent synthetic speech to the video conference server, and wherein the video conference server transmits the original video of the stuttering participant along with the fluent synthetic speech to the one or more other participants.

18. The video conference system of claim 13, wherein the FDT video conference client comprises:
an avatar generator module that is configured to replace the original video of the stuttering participant with avatar video of an avatar selected by the stuttering participant, wherein the selected avatar is indicated by an avatar descriptor included in the user configuration data;
wherein the FDT video conference client is configured to send the avatar video along with the fluent synthetic speech to the video conference server, and wherein the video conference server transmits the avatar video along with the fluent synthetic speech to the one or more other participants, and wherein the avatar video includes lip movements that are informed by the fluent synthetic speech.

19. The video conference system of claim 11, wherein the FDT video conference client does not transmit the original audio of the stuttering participant to the video conference server.
